(19) United States
(12) Patent Application Publication
(10) Pub. No.: US 2004/0148278 A1
(43) Pub. Date: Jul. 29, 2004

(54) System and method for providing content warehouse

(76) Inventors: Amir Milo, Levallois-Perret (FR); Serge Abiteboul, Severes (FR); Sophie Cluet, Suresnes (FR)

Correspondence Address: NATH & ASSOCIATES, 1030 15th STREET, 6TH FLOOR, WASHINGTON, DC, 20005, US

(21) Appl. No.: 10/400,652

(22) Filed: Mar. 28, 2003

Related U.S. Application Data
(60) Provisional application No. 60/441,310, filed on Jan. 22, 2003.

(51) Int. Cl. G06F 7/00

(52) U.S. Cl. 707/3

(57) ABSTRACT

A method for dynamically constructing a scalable content warehouse for information that includes semi-structured data. The method includes performing data acquisition from a plurality of data repositories, some of which store data that is of semi-structured or non-structured form. The acquired data is enriched and stored in a storage. The enriching includes utilizing enriching utilities some of which are semi-structured related enriching utilities. There is further provided provision of semi-structured access and query utilities for accessing the stored semi-structured data.

### FIELD OF THE INVENTION

This invention relates to data warehouse and data warehouse applications.

### Related Art

U.S. patent publication 20020073104—discloses Data storage and retrieval methods in which data is stored in records within a file storage system, and desired records are identified and/or selected by searching index files which map search criteria into appropriate records. Each index file includes a header with header entries and a body with body entries. Each header entry comprises a header-to-body pointer which points to a location in the body of the same index file which is the starting point of the body entries related to the header-to-body pointer pointing thereto. The body entries in turn comprise body-to-record-pointers, which point to the records within the file storage system satisfying the search criteria. Alternatively, the body entries may comprise body-to-body pointers which point to body entries in a second index file, which in turn point to the records within the file storage system satisfying the search criteria. The records are stored in HTML format.

U.S. patent publication 20020099710—discloses a data warehouse portal for providing a client with an overall view of one or more data warehouses to aid in the analysis of data in the warehouse(s). The portal allows the client to gain an insight about the data to determine how the data is used, who uses the data, if additional data sources are required, and what impact a data change may have.

The portal reads and/or searches metadata and/or XML schemas from the data warehouses and tools available for accessing data stored in the data warehouse, and display the data warehouse information through a browser in numerous ways, such as hierarchical, user and application views. Other views may include extraction, usage, historical and comparison.

U.S. patent publication 20020147734—discloses a policy based archiving system receives data files in various formats and with various attributes. The archiving system examines each data file's attributes to correlate each data file with at least one policy by employing policy predicates. A policy is a collection of actions and decisions relating to the various storage and processing modules of the archiving system. In one aspect, the archiving system scans the content of a received data file to correlate the data file to a policy in accordance with the semantic content of the data file.

### BACKGROUND OF THE INVENTION

Enterprises have an array of appropriate tools for accessing and managing the structured and quantitative information of the organization, e.g., databases, data warehouses, data marts, OLAP, report generators. Note that data warehouse applications normally deal with structured data characterized by having a fixed schema, such as in relational databases. Numerous data warehouse and data warehouse related products are commercially available from companies such as Cognos Corp., Computer Associates (CA), Informatica Corp., NCR, Oracle Corp., PeopleSoft and others. Unlike data that have a fixed schema as discussed above, data that do not conform to a fixed schema are referred to as semi-structured or non structured. This type of data is often irregular, describes both quantative and non-quantative information, and in the case of semi-structured data only loosely defined. Non-structured data such as unformatted textual information, as well as semi-structured data such as XML and meta-information (about audio, video, photos, etc.), typically reside in many heterogeneous environments and are, as a rule, hard to access and administrate and consequently, relatively poorly exploited

As is well known, Semi-structured data models, e.g., XML, are self-describing. The structure of the information is typically provided by tags that are contained in the information. They can describe tree structures and hierarchies and are considered to overcome the rigidity of the relational model. They allow capturing structured data such as relational, but also less regular, hierarchical or graph data, as well as plain text. The underlying philosophy is that content typically has some structure but is often not as regular as that expected by structured data, such as in relational systems. All content may be fit in a semi-structured model so that organizations, building on, e.g. XML technology, can take full advantage of content at reasonable application costs. Note that data that is neither semi-structured nor structured are referred herein as non structured data. Exemplary non structured data are unformatted text files, email files etc.

There is, thus, a need in the art to extend the use of data warehouse also to semi-structured and non-structured data.

### SUMMARY OF THE INVENTION

The invention provides for a method for dynamically constructing a scalable content warehouse for information that includes semi-structured data, comprising:

i. acquiring data from a plurality of data repositories, at least some of which store data that is selected from a group that consists of semi-structured data or non-structured data;

ii. enriching and storing the acquired data in a storage giving rise to semi-structured stored data; said enriching includes utilizing enriching utilities, at least some of which are semi-structured related enriching utilities;

providing semi-structured access and query utilities for accessing the stored semi-structured data.

The invention further provides for a system for dynamically constructing a scalable content warehouse for information that includes semi-structured data, comprising:

acquiring module configured to acquire data from a plurality of data repositories, at least some of which store data that is selected from a group that consists of semi-structured data or non-structured data;

enriching module and associated store module configured to enrich and store the acquired data in a storage giving rise to semi-structured stored data; said enriching module includes utilizing enriching utilities, at least some of which are semi-structured related enriching utilities;

information delivery module configured to provide semi-structured access and query utilities for accessing the stored semi-structured data.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows a generalized system architecture of a content warehouse in accordance with one embodiment of the invention;

FIG. 2 shows an architecture of an acquisition module of a content warehouse system, in accordance with an embodiment of the invention;

FIGS. 2A-2D show exemplary source repositories serving as input for a CWH (Content Warehouse), in accordance with an embodiment of the invention;

FIG. 2E shows a table containing loaded files related data;

FIG. 3 shows an architecture of an enrichment module of a content warehouse system, in accordance with an embodiment of the invention;

FIGS. 3A-B show exemplary enriched documents after undergoing enrichment, in accordance with an embodiment of the invention;

FIG. 4 illustrates, schematically, a generation of relational view, according to the prior art;

FIG. 5 illustrates, generally, a view for semi-structured documents, in accordance with an embodiment of the invention;

FIG. 6 is a flow chart illustrating, in general, the operational steps involved in the creation of a view, in accordance with an embodiment of the invention;

FIGS. 7A-D illustrate schematically exemplary view elements, in accordance with an embodiment of the invention;

FIG. 8A illustrates an exemplary path to path mappings for the art cluster, in accordance with an embodiment of the invention;

FIGS. 8B-C illustrate a concrete DTD and path to path mappings for the tourism cluster, in accordance with an embodiment of the invention;

FIGS. 9A-B illustrate a specific implementation of the path-to-path mappings for the art cluster, in accordance with an embodiment of the invention;

FIG. 9C illustrates a specific implementation of the path-to-path mappings for the tourism cluster, in accordance with an embodiment of the invention;

FIG. 10 illustrates a system architecture, in accordance with an embodiment of the invention;

FIG. 11 illustrates an annotated abstract DTD stored in an interface machine, in accordance with an embodiment of the invention;

FIG. 12 illustrates a generalized flow diagram of structured query processing steps, in accordance with one embodiment of the invention;

FIG. 13 illustrates an exemplary abstract query tree, in accordance with an embodiment of the invention;

FIG. 14 illustrates an input/output data pertaining to the processing of structured query in an interface machine, in accordance with an embodiment of the invention;

FIG. 15 illustrates an abstract query tree and a corresponding concrete query tree, in accordance with one embodiment of the invention;

FIGS. 16A-B illustrate, graphically, the operation of query translating procedure in an index machine, in accordance with one embodiment of the invention;

FIG. 17 illustrates a coding scheme, used in query evaluation procedure, in accordance with an embodiment of the invention;

FIG. 18 illustrates, schematically, an index data structure, in accordance with an embodiment of the invention;

FIGS. 19A-B illustrate a sequence of join operations, used in a query evaluation process, in accordance with an embodiment of the invention;

FIGS. 20A-D illustrate an exemplary scenario where an answer to a query resides in more than one document, in accordance with one embodiment of the invention;

FIG. 21 illustrates the pertinent annotated tree in the exemplary scenario of FIGS. 20A-D;

FIGS. 22A-D illustrate the pertinent join operations in the exemplary scenario of FIGS. 20A-D;

FIG. 23 illustrates a specific join operation used in connection with the exemplary scenario of FIGS. 20A-D.

FIG. 24 illustrates, schematically, a generalized system architecture in accordance with one embodiment of the invention;

FIG. 25 illustrates, schematically, a query processor employing a relevance ranking module in accordance with one embodiment the invention;

FIG. 26 illustrates, schematically, use of a query language for specifying relevance ranking, in accordance with one embodiment of the invention;

FIG. 27 illustrates, schematically, use of a query language for specifying relevance ranking, in accordance with another embodiment of the invention;

FIG. 28 illustrates a description of an XML schema serving for exemplifying the operation of the system and method of the invention in accordance with an embodiment of the invention;

FIGS. 29A-C illustrate, schematically, use of an operator for specifying relevance ranking in respect of three different specific queries, in accordance with one embodiment of the invention;

FIGS. 30A-C illustrate, schematically, specific tree patterns evaluated in respect of a specific query, in accordance with an embodiment of the invention;

FIG. 31 illustrates a coding scheme, used in query evaluation procedure, in accordance with an embodiment of the invention;

FIG. 32 illustrates, schematically, an index data structure, used in query evaluation procedure, in accordance with an embodiment of the invention;

FIGS. 33A-B illustrate a sequence of join operations, used in a query evaluation process, in accordance with an embodiment of the invention; and

FIG. 34 illustrates, schematically, a sequence of algebraic operations used in a query evaluation process, in accordance with an embodiment of the invention.

FIG. 35 shows an exemplary screen layout for illustrating the operation of Querying Browsing & Annotation module, in accordance with an embodiment of the invention.

### DETAILED DESCRIPTION OF THE INVENTION

Content Warehouse (CWH) in accordance with the invention is built mainly, although not necessarily exclusively, on semi-structured data. The solution is based on a repository of cleaned and enriched content (stored in e.g. semi-structured form) that is built without modifying the existing repositories and their associated applications or processes. Put differently, additional repository of cleaned and enriched content is constructed as well as additional utilities for querying the newly constructed content. However, if users wish to continue and use the original repositories (which serve as source repositories for the newly constructed content repository) as well as their associated processes and applications they can do so bearing in mind that the construction of the content warehouse is a non-destructive process.

Reverting now to the content repository, it aggregates and integrates content (typically in semi-structured from) from multiple operational environments to provide accurate and relevant analysis and reporting to decision makers, knowledge workers or to anyone needing to understand particular aspects of the organization's content. Thus, the repository may serve an entire enterprise as a Content Warehouse or at the department level, as a Content Mart (being one form of CWH).

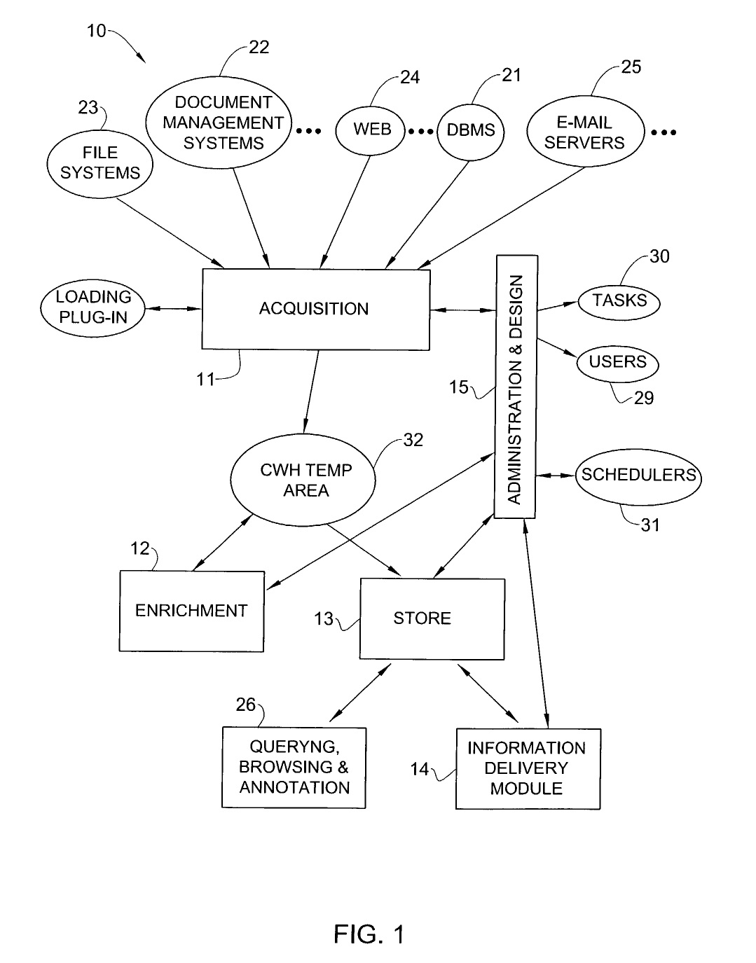

FIG. 1 shows a CWH system 10 composed of Content Acquisition 11, Enrichment 12, Store 13, Information delivery 14, Administration & Design 15, and Browsing Querying & Annotation (BQA) module 26.

The primary unit of information that is stored in the CWH is Content Element being typically in a semi-structured form. Note, however, that content element originate from (i) source repositories which store non-structured data (e.g. unformatted text file) and/or (ii) source repositories which store semi-structured data such as XML files, document management systems, file systems, web sites, email servers, LDAPs and others which normally hold data also in semi-structured form. Optionally content elements may also originate from structured data such as documents, files, relational tuples, RDBMS like in DWH, data warehouses or other structured data units.

Note that the term content Elements also embraces references to elements that are outside of the CWH itself, for example, a link to a video file. For convenience, content elements are referred to occasionally also as content data, or in short data.

The original format of data from which Content Elements originate is not limited and can be any format or mixture of formats. Moreover, data from which Content Elements originate may come in different natural languages (e.g. English, French, etc.).

Note, generally, that the invention is not bound to a particular size or type of data from which content elements originate. For example, and as specified above, content elements can originate from a document, an email, a tuple in a DBMS, an XML document and the like, however, and by way of example only they can also originate form portion of above, e.g. a portion of such document such as the Subject field of an email or a collection of such elements such as an email folder. Note also that certain data types may be stored in different forms in different source repositories. Thus, by way of non limiting example, emails may be stored in a first server repository in a non-structured form, whereas in other server system it may be stored in semi-structured form. The system and method of the invention does not pose any constraint on the manner of storing the data in the source repositories.

Reverting now to FIG. 1, there is shown an Acquisition Module 11, which by this embodiment, performs the following services, including:

Interpreting a Loading Schema that is defined by the CWH designer.

Locating Content Elements like: documents, parts of documents, files, relational tuples, and similar in the source systems. Note that by this embodiment Content Elements may originate from RDBMS like in DWH 21, but they may also originate from document management systems 22, file systems 23, web sites 24, email servers 25, and many more. The Content Elements original format is not limited and can be any format or mixture of formats. Moreover, Content Elements may come in different languages.

Executing Loading Tasks: deciding which content elements to load, from which physical (or other, e.g. virtual) locations, and which Loading Plug-ins to use. The Loading Plug-in's 34 may be specific to the source systems. E.g. a plug-in to load Oracle data from a given RDBMS schema, a plug-in to load emails from MS Outlook, a plug-in to fetch files from the web, etc. The new content is loaded in CWH and possibly in a temporary area, the CWH Temp Area 32, to wait for further processing. Note that loading tasks do not necessarily employ Plug-ins, and accordingly other loading mechanisms are applicable, depending upon the particular application.

Grouping several elementary Loading Tasks into a (complex) Loading Task to ensure optimal resource utilization.

Controlling the execution of Loading Tasks, in terms of, e.g. checking exit status, handling exceptions like abnormal termination, re-staring processes, etc.

Administrating the various loading tasks in terms of, e.g. recording which process run, where did it run and how did it finish, which user made changes, which content elements were loaded/updated/deleted, by whom and when.

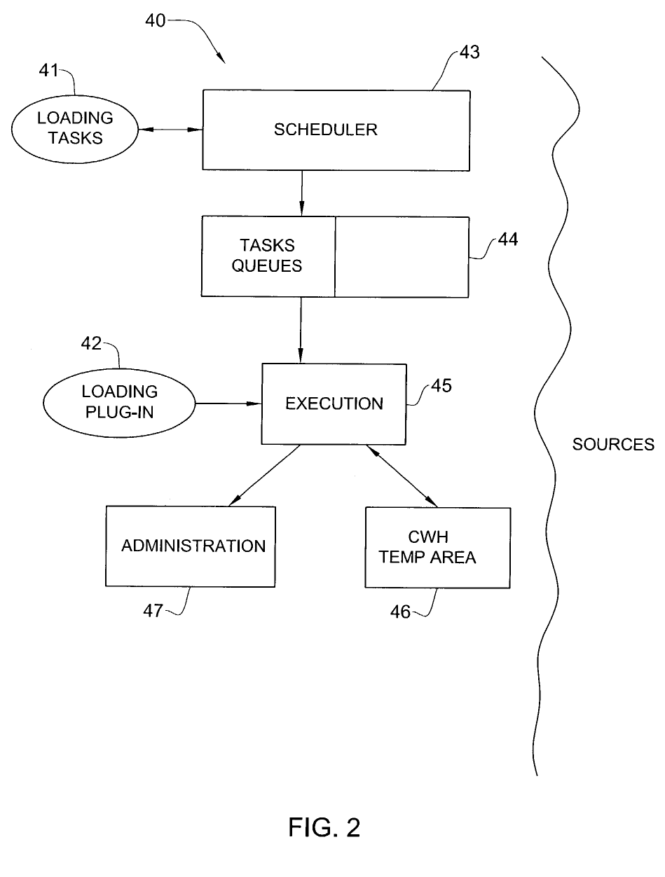

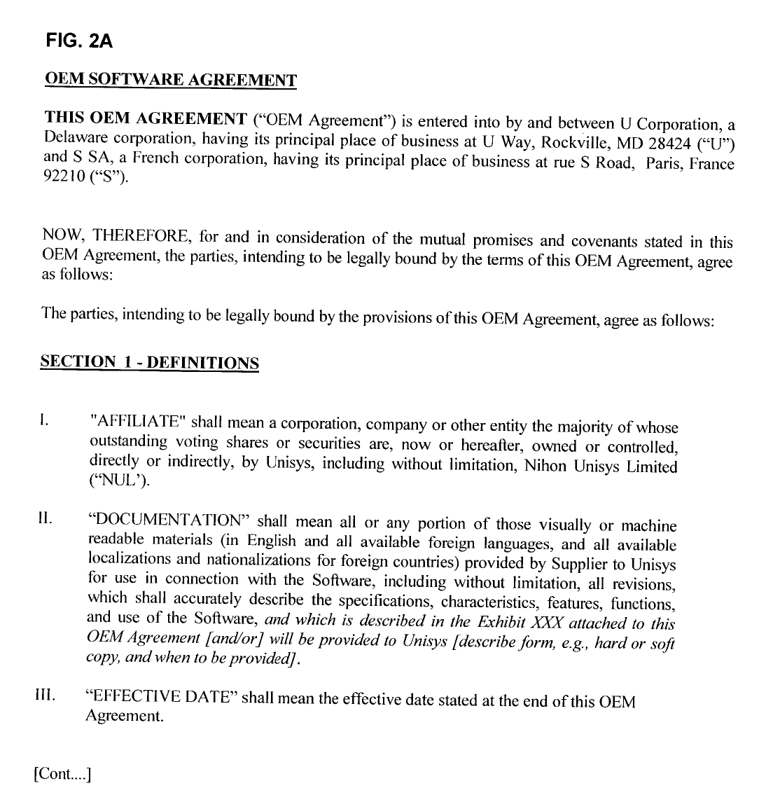

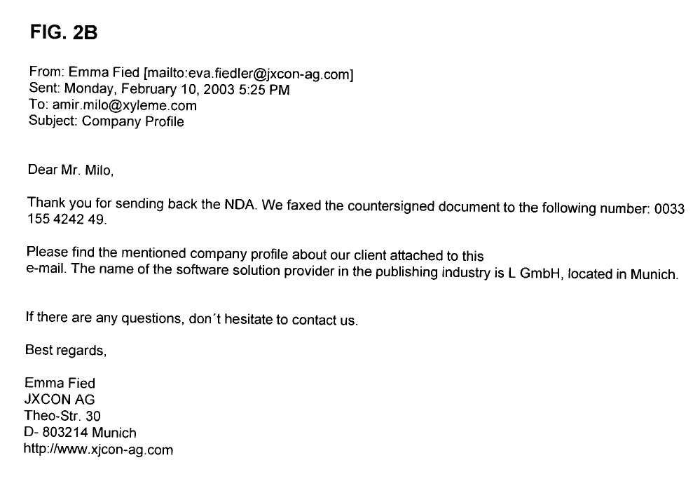

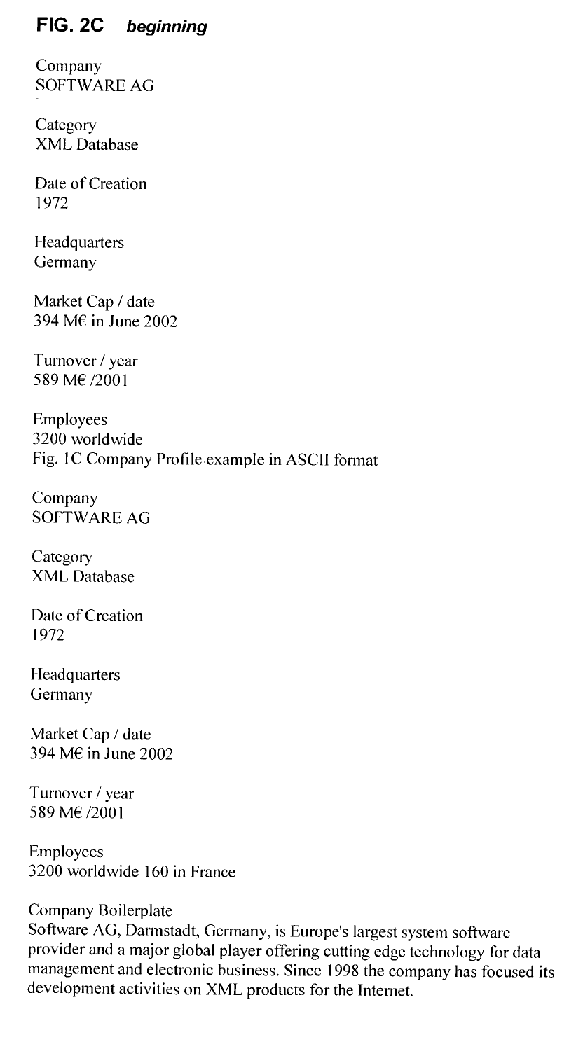

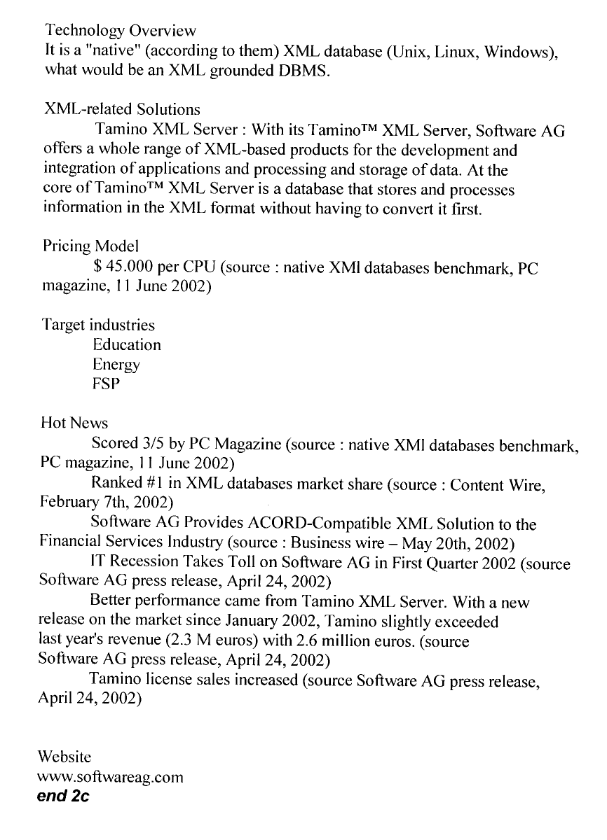

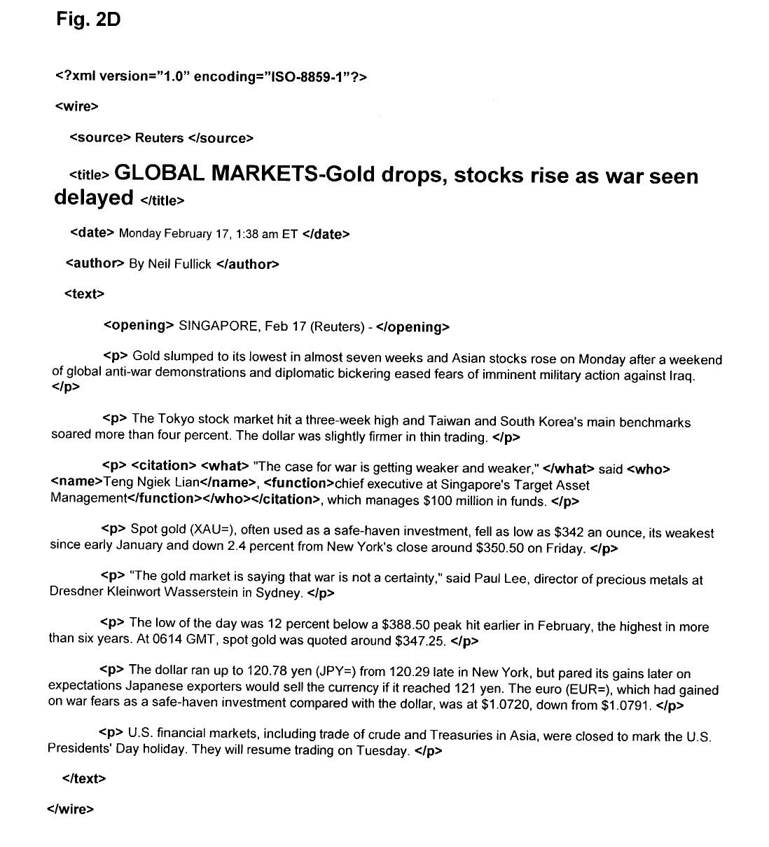

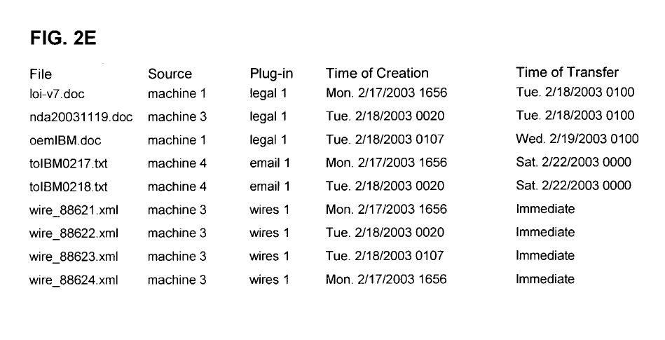

Note that the acquisition module may involve one or more other tasks in addition or in lieu of the above tasks. The operation of the Acquisition module will be described with greater detail with reference also to FIG. 2 below.

Turning now to the Enrichment Module (12), by this embodiment, it performs the following services, including:

Interpreting the Enrichment Schema that was defined by the CWH designer. Such interpretation may involve, for example, converting the schema expressed in a given language to enrichment activities.

Identifying Enrichment Tasks that are “ready” to be performed and transfer them to the Enrichment Queue. Note that the CWH designer as part of the Enrichment Schema defines Enrichment Tasks (as will be discussed also with reference to the Administration and design module 15, below). Enrichment Tasks contain instructions about which enrichment utilities should be invoked, on which Content Elements, at which condition, and where should the result be put.

Executing the activities that are defined by the Enrichment Tasks in the queue on Content Elements that reside in the CWH (possibly in the CWH Temp Area) and modify the CWH accordingly.

Grouping several elementary Enrichment Tasks into a (complex) Enrichment Task to ensure optimal resource utilization.

Controlling the execution of Enrichment Tasks in terms of, e.g. checking exit status, handling exceptions like abnormal termination, re-staring processes, etc.

Administering the various Enrichment Tasks in terms of, e.g. recording which process run, where did it run and how did it finish, which user made changes, which content elements were loaded/updated/deleted, by whom and when.

Note that the enrichment module (12) may involve one or more other tasks in addition or in lieu of the above tasks.

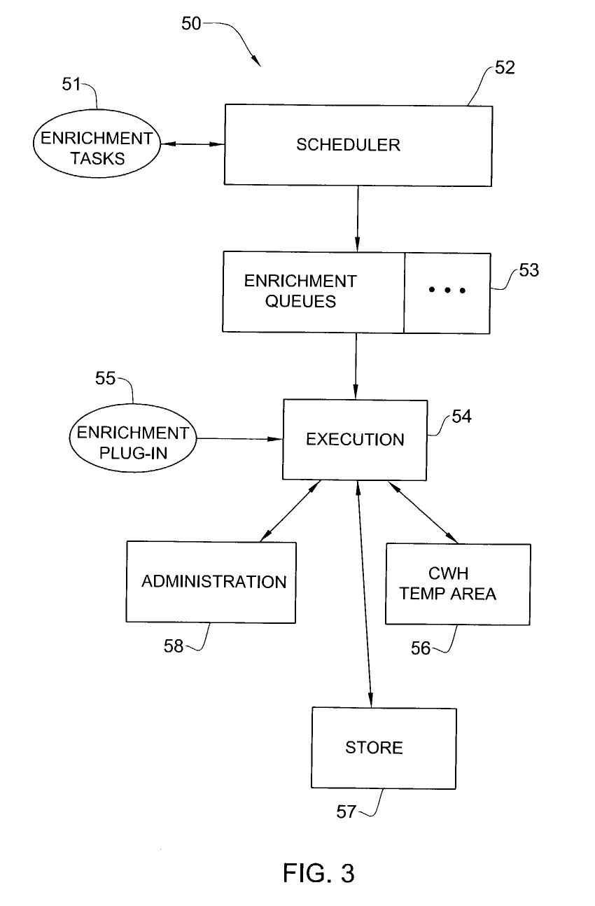

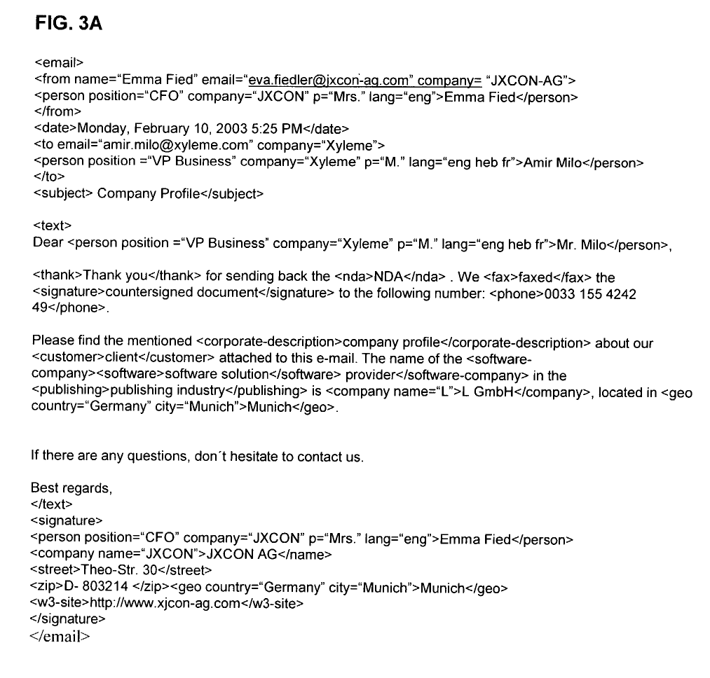

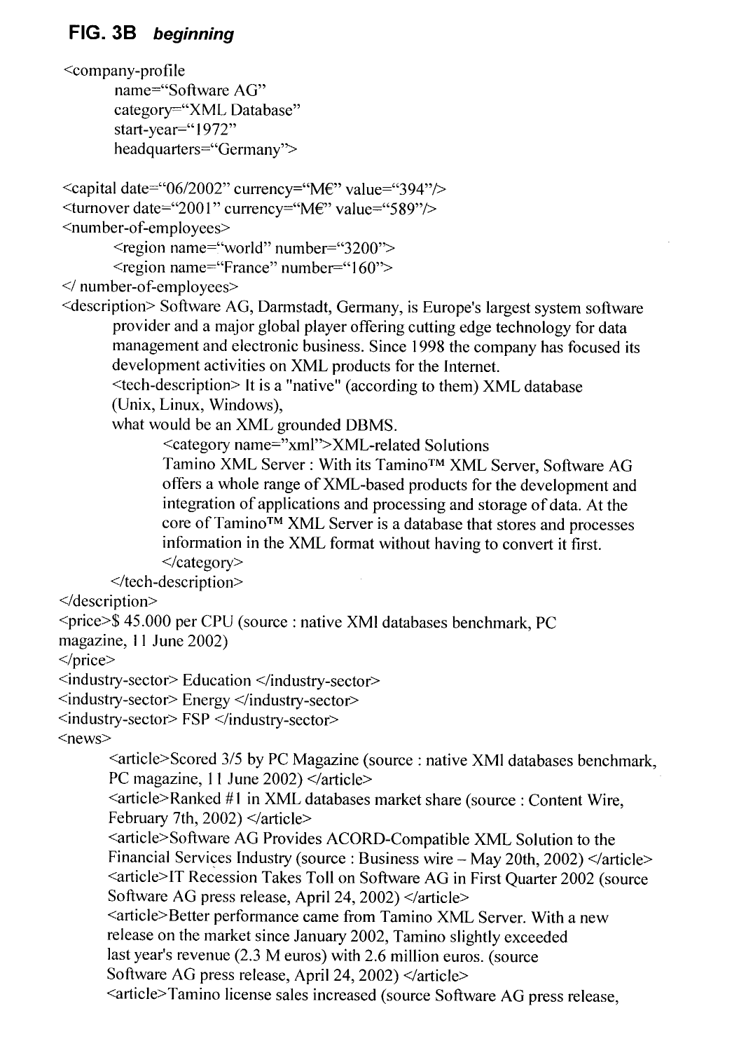

The operation of the enrichment module will be described with greater detail with reference also to FIG. 3 below.

Turning now to the Store Module (13), by this embodiment, it performs the following services, including:

Physical and logical storage of semi-structured data.

Indexing.

Building user views and in particular, integration of Concrete Document Type Definitions (DTD's) (or XML schemas) (being examples of Document Structured Summaries) to an abstract view of these DTDs

Querying documents using an SQL-like query language, e.g. Xquery

Maintaining versions of documents and provision of support for query subscription (i.e. invoking queries if certain condition(s) is met. By one embodiment, the Store may optionally maintain several latest versions of a document, as well as the differences between two or more versions. A delta document contains the differences between the versions of a document. The delta document is a separate document that is stored with the most recent version of the document. A delta document elaborates all of the differences between the current version and the previous one.

Note that the store module (13) may involve one or more other tasks in addition or in lieu of the above tasks.

The Information Delivery Module 14 by this embodiment, performs the following services, including:

User Interface that enables the CWH designer(s) to define templates of CDR (Content Driven Report) for obtaining Parameterized Reports.

User interface for enabling users to retrieve information from the CWH and to perform data manipulation operations, including aggregate, classify, prioritize and style this information according to the user's parameters and profiles.

Support query and analysis requests in both continuous (push) and ad-hoc (pull) both for content and for changes in the content.

Note that the Information Delivery Module (14) may involve one or more other tasks in addition or in lieu of the above tasks.

The Browsing Querying & Annotation Module 26, by this embodiment, performs the following services, including:

User Interface that enables the CWH designers and users to easily browse the CWH and search content elements in the CWH.

User Interface that enables users to annotate Content Elements by updating tag values or adding new tags and values.

Note that the Browsing Querying & Annotation module (26) may involve one or more other tasks in addition or in lieu of the above tasks.

The Administration & Design Module 15 provides the following services:

Definition of Loading Schemas

Definition of Enrichment Schemas

Definition of Users 29, User groups, Resources, Processes 30, Authorizations and the like

Performance and Resource Monitoring as well as monitoring of the usage of the CWH.

On Going maintenance and scheduling 31 of the above (back up, recovery, etc.)

Note that the Administration & Design Module module (15) may involve one or more other tasks in addition or in lieu of the above tasks.

Note that the invention is, by no means bound by the specific system architecture of FIG. 1.

Having described generally a non limiting system architecture of CWH in accordance with an embodiment of the invention, there follows now a more detailed description of the respective modules, with reference also to a non-limiting example.

Accordingly, attention is now drawn to FIG. 2 showing architecture of an acquisition module 11 of content warehouse system 10, in accordance with an embodiment of the invention.

By this embodiment, the feeding of new Content Elements to the CWH is performed by the Acquisition module 11 according to the definitions made by the CWH designer.

In the Design Phase, the CWH designer defines the Loading Schema. By one embodiment, the Loading Schema is composed of Loading Tasks 41 that define which data to load, from which physical location, and which Loading Plug-in 42 to use and when to perform the loading, e.g. with some frequency or when some event or events occur.

Loading Plug-ins may be specific to the source system, e.g. a plug in to load Oracle data from a given RDBMS schema, a plug in to load emails from MS Outlook, a plug in to fetch files from a particular web site, etc.

The CWH designer may also specify some processing to be performed at load time, e.g., content transformation or some monitoring to perform at that time. The Design phase is an on-going process that is repeated by the CWH designer(s) in order to update the Loading Scheme with new or modified tasks.

In operation, the Acquisition module 40 identifies Loading Task (from a repertoire of loading tasks 41) that have to be performed based on the specifications. Scheduler 43 groups and schedules Loading Tasks to ensure optimal resource utilization. Grouping the tasks is of course applicable in the case that it will enable to optimize resources without creating consistency problems. By way of non-limiting example, when few tasks are to be applied to the same content element it may be preferable to group then together rather than apply them to the content element one at a time. The scheduled (and possibly grouped) tasks are fed to a time based tasks queue 44.

The tasks are then fed from the tasks queue 44 to execute Loading Tasks module 45—applying the appropriate loading plug-ins 42. The results are stored in CWH, typically in the CWH Temp Area 46, to wait for further processing by the Enrichment module before being delivered to the CWH.

Whenever necessary, Administration Module 47 updates various administrative tables to inform the CWH on the new acquired elements and possibly index the new content.

Note that by this embodiment the Processing in module 40 is parallel and on going. Note also that new Loading Tasks may be triggered by predetermined condition(s), e.g. a loading of new content element. In other words, loading of content element of a given type may constitute a trigger condition for another loading task, etc. Other triggering conditions may be enrichment of elements, user queries, time dependent loading tasks, etc. The invention is not bound by this particular example.

Examples of Loading Tasks condition:

A new email by the CEO was added to the email server—load it to the CWH

While enriching Content Element (a), the system decided that document (b) should be loaded to the CWH

A news article (c) is queried often—load its attachments to the CWH.

For a better understanding of the foregoing, consider the following example in connection with CWH for legal information:

Thus, the raw legal information is spread over several repositories that reside in various machines and locations, .e.g. in the following five source repositories:

Source 1: Legal documents related to the deals of division A: contracts, orders, Letter of Intents, etc. These documents are in MS-Word documents (stored by this example as non-structured data or in other, possibly semi-structured, available form) and stored in a file systems on machines 1,2 & 3. An example of a partial document is shown in FIG. 2A.

Source 2: Legal documents related to the deals of division B. These documents are in MS-Word documents (stored by this example as non-structured data or in other, possibly semi-structured, available form) and stored in a document management system on machine 2.

Source 3: Email repository (stored by this example asnon-structured data or in other, possibly semi-structured, available form) stored on machine 4. An example of a partial document is shown in FIG. 2B.

Source 4: Companies profiles' in ASCII format (i.e. stored by this example as non-structured data or in other, possibly semi-structured, available form) stored on machine 4. An example of a partial document is shown in FIG. 2C.

Source 5: News Wires from Reuters, Thomson Financials and Bloomberg in XML format (stored by this example as non-structured data) stored on machine 3. An example of a partial document is shown in FIG. 2D.

Acquisition phase Definition and Processing:

The CM designer defines a loading schema (that include loading tasks 41 triggered by scheduler 43) for the above sources. A typical schema for the above sources would be:

Load Task 1: Executed daily at 01:00AM, for each new document at Source 1 using plug-in “legal 1”. Plug-in “legal 1” has the capabilities and authorization to transfer files from the designated directories on machines 1,2 and 3 to the Temp Area.

Load Task 2: Executed weekly on Sat. at 12:00AM, re-load all documents at Source 3 using plug-in “emails 1”.

Load Task 3: Executed whenever a new document arrives to source 5, load the document using plug-in “wires 1”.

Note that the above tasks (Load tasks 1 to 3) are provided for illustrative purposes only and accordingly they form just a subset of the loading tasks that are be required to load all the above sources.

Based on the schedule that was created using the loading tasks (as controlled by scheduler 43), the Acquisition module will transfer (using execution module 45 and loading plug-in module 42) the relevant files data to the CWH Temp Area (46 in FIG. 2). FIG. 2E illustrates an example of a table containing data related to loaded files, as was generated or gathered by Administration module 47. By this specific example the table contains the following data (fields) per each loading transaction (of which 9 are shown in FIG. 2E): File standing for the file name that is loaded from a source repository, Source standing for the physical machine where the file originally reside, Plug-in: the actual Plug-in (from the loading plug-in storage 42) that was used in the loading operation, Time of Creation signifying the creation time of the file, and Time of Transfer signifying the actual time that the file was transferred for storage at CWH temp area 46. Those versed in the art will readily appreciate that other statistics may be generated or gathered by Administration module 47, depending upon the particular application.

In some cases, the Acquisition module (through its' scheduler sub-module 43) groups loading tasks to improve the resources utilization. For instance, if Load Task 1 identified files that need to be transferred at 14:00 from machine 3 to the Temp Area and Load Task 2 identified other files that need to be transferred at 14:00 from machine 3 to the Temp Area, a combined transfer task can be created that will copy all these files as one block.

Moving now to FIG. 3, there is shown architecture of an enrichment module of a content warehouse system, in accordance with an embodiment of the invention. Thus, the enrichment of the CWH is the process of adding value to content elements. This process is achieved by the Enrichment module 50 by applying enrichment utilities to the content according to the definitions made by the CWH designer.

The Enrichment Utilities are used to improve the value of content. The enrichment works typically (although not necessarily) at the content element level. The enrichment utilities can be typically (although not necessarily) categorized to:

Syntactic Enrichments, like:

Identify the format of some content element and add this information to the content element

Remove duplication of content element

Remove annexes from MS Word documents

Linguistic Enrichments, like:

Identify the natural language of a content element (e.g. in English or French), and depending upon the identified language perform a certain task, e.g. if a word is in the English language, translate it to French, using known per se translation service).

Extract concepts that may be associated with a content element. E.g. Sport, Beckham, Mondial 2002, Football

Isolate a portion of content element and tag it with meta information. Like: <Company Name>, <Address>, etc.

Build a summary of a content element

Generate a Table of Content or a Table of Index for a content element

Transformation tools (wrappers) that are possibly specific to the generating application or the type of the content element, like:

An XSL/T transformation to map e.g. one DTD to another one

Translate to XML a MS Visio document

Transform Oracle data to another format

Note that the invention is not bound by the specified categories and/or by the utilities in each category.

Those versed in the art will readily appreciate that certain enrichment utilities are semi-structured related in the sense that they are normally not used in clearance utilities that are utilized in conventional data warehouses (DWH). More specifically, a conventional DWH stores, as a rule, data in structured form. Such data may require application of certain clearance utilities such as Remove duplication of content element (specified as one of the above syntactic enrichment utilities) in order to improve the quality and integrity of the data. However, due to the structured nature of the data stored in conventional DWH, there is no need to apply enrichment utilizes such as “Build a summary of a content element, or “Isolate a portion of content element and tag it with meta information”, as specified above. The latter (and many other semi-structured related enrichment utilities) are required due to the semi-structured nature of the data (stored in the CWH), which, as specified above, are only partially structured and require certain enhancement (through the semi-structured related utilities) to facilitate appropriate querying and utilization according users' needs.

Note also that the various enrichment utilities are applied to content element that not necessarily originate from a full email or document. Thus, depending upon the particular application it may be applied to a portion of such an elements (e.g. the Subject field of the email) and/or a collection of such elements (e.g. an email folder).

The utilities that are used adhere to some “rules of engagement” regarding interfaces, method of calling, method of returning the results, etc.

Bearing this in mind, a typical yet not exclusive sequence of enrichment process will now be described, starting with a Design Phase. Thus, the CWH designer defines an Enrichment Schema. The Enrichment Schema is composed of Enrichment Tasks (51). An Enrichment Task specifies for example (i) a condition (or event) that will start the invocation of the task, (ii) the content elements that are involved and (iii) the Enrichment Utilities to be used and where to store the result of the enrichment, possibly inside the content element. The conditions may be guided by the content itself or be specified under the form of a workflow.

Typical yet not exclusive conditions are:

At a specific time (e.g. every day at 2AM, or 1 year after loading)

After completion of some Loading or Enrichment Tasks

Conditions based on the usage of the CWH such as every 10 executions of a particular query or after certain updates.

The Design phase is an on-going process that is repeated by the CWH designer(s) in order to update the Enrichment Schema with new or modified tasks.

Moving now to the process phase it includes by this embodiment Identifying (using scheduler module 52) task or tasks (from repertoire of available tasks 51) that needs to be executed based on the specification of its firing. The scheduler 52 may group and schedule enrichment tasks to a (complex) enrichment task in order to ensure optimal resource utilization without creating consistency problems, and insert them into the time based style Loading Queue 53.

In order to execute 54 the Enrichment Tasks—appropriate enrichment plug-in 55 is applied on the relevant content element and the result is stored, possibly in CWH temp area 56 or in store 57 according to the Loading Task definition.

As before, Administration Module 58 updates various administrative tables to inform the CWH that the task has been executed and the new content elements are available. It also monitors the execution of the Enrichment Tasks.

Note also that by this embodiment the Processing in module 50 is parallel and on-going.

Note that by this embodiment the Processing in module 50 is parallel and on going. Note also that new Triggering Tasks may be triggered by predetermined condition(s), e.g. a loading of new content element. In other words, a. loading of content element of a given type may constitute a trigger condition for another triggering task, etc. Other triggering conditions may be for example enrichment of elements, user queries, time dependent loading tasks, etc. The invention is not bound by this particular example.

For a better understanding of the foregoing, the operation of the enrichment module will be exemplified with reference to the same example described with reference to FIGS. 2A-2E above.

Thus, at the design phase, The CWH designer defines an enrichment schema for the above files. A typical schema for the above file types includes Enrichment tasks (51) as follows:

Enrichment Task 1: Upon arrival, translate all emails files to XML using plug-in “email2XML” (stored in 55), and transfer them from the Temp Area (56) to the CWH storage (57). Converting text such as emails to XML representation can be realized, using known per se tools commercially available tools, such as from Autonomy Inc. US.

Enrichment Task 2: Every day at 03:00 AM, remove annexes from every content element originating from a legal document that is over 20 pages, using plug-in “rmAnnex” (stored in 55), then summarize the legal documents using plug-in “summary” (stored in 55).

Enrichment Task 3: Every day at 03:00 AM, extract company names and tag them from every content element coming from a news wire, using plug-in “extractComapnyNames” (stored in 55).

Enrichment Task 4: If the email content element was accessed more than 5 times, extract concepts from it, using plug-in “extractConcepts” (stored in 55). ExtractConcept plug-in can be implemented using commercially technologies available from companies like Gammasite, Inxight etc.

Some enrichments may result in servicing subscription queries, e.g., after Enrichment Task 3, a user that registered his interest in “Unisys” will be notified when a document mentioning that company is detected.

The above tasks are just a subset of the enrichment tasks that will be required to enrich all the above sources.

Based on the schedule that was created using the enrichment tasks (which result in placing the tasks in the enrichment queue 53—under the control of scheduler 52), the Enrichment module through its execution module 54 will enrich the relevant content elements using the enrichment tasks.

### EXAMPLE

1) For the data of FIG. 2A the following tags can be created after extracting “Party” tag:

The Original Text:

“ . . . U Corporation, a Delaware corporation, having its principal place of business at U Way, Rockville, Md. 28424 (“U”) . . . ”

The tags that were extracted:

<Party>
<Type=”external entity”>
U corporation
<legal structure> Delaware corporation </legal structure>
<address> U Way, Rockville, MD 28424 </address>
<abbrv> “U” </abbrv>
</Party>

The latter conversion utilizes convert to XML plug-in (similar to email2XML of the specified Enrichment Task 1, and the “extractCompanyNames” specified in Enrichment task 3, above).

FIG. 3A shows the example of FIG. 2B, after being subjected to enrichment utilities (including using the specified email2XML enrichment task 1) that include transformation to XML and some meta-data extraction using e.g. company name extraction plug-in for extracting the company name.

FIG. 3B shows the example of FIG. 2C, after being subjected to enrichment utilities that include transformation to XML and concept extraction. In some cases, the Enrichment module (through scheduler 52) groups enrichment tasks to improve the resources utilization. If Enrichment Task 2 identified several files that need to be summarized, it can (through the scheduler) feed the summarization plug-in with all the files at once rather than one after the other.

The enriched and/or acquired data are stored in storage 13 (which includes the temp area 32) (both shown in FIG. 1). By this embodiment, the Store of the CWH provides means to physically store, index, query, retrieve, integrate, monitor and view large (and scalable) amounts of semi-structured content in reasonable time. It provides the equivalent of RDBMS for data warehouse, however with many adaptations and changes.

By this embodiment, the Store module executes several types of operations: Load/Update, Query and Monitor Content Element(s). The users are sending queries in a standard Query Language to execute their operations. Examples of query languages to semi-structured stores are Xquery, XMLSQL, variations of them and others.

The principles of execution of operations for semi-structured content are similar in certain respects to structured content databases, and include: an index, a data store, a query manager, optimizer, view manager, alert manager, transaction manager, recovery, etc. However, due to the semi-structured nature of the stored data, several non-standard operations are required in departure from what is implemented in conventional DWH.

Note that in accordance with one embodiment, the store module 13 is composed of one or more repositories. These repositories may be distributed among different physical machines within the content warehouse. New repositories may be incrementally added to the Store to accommodate the information growth. A repository is organized as a set of clusters. A cluster is a container of semi-structured documents (including their structure description documents, if any), which are stored and possibly indexed together. Each cluster has a name, and resides in a single repository.

The following operations are performed in store module 13 of FIG. 1. The invention is not bound by these specific operations. Constructing clusters and classifying the stored/enriched data elements to clusters using either manual or automatic (semi-automatic) classification tools.

Constructing schema, i.e. document summaries such as XML schema or concrete DTD) to loaded content elements that are devoid of data schema. Note that whereas structured data is always associated with schema, this is not necessarily true for semi-structured or non structured data that are loaded to the CWH in accordance with the invention. Constructing views including view schema and view definition (e.g. abstract DTDs and path to path mappings between abstract DTD and concrete DTDs or XML schemas).

Construct Index to Content Elements to include both full text indexing and full tags and structure indexing, for facilitating efficient access to data.

Queries written in the query language are run against the views, which provides an interface to the actual data.

The query language is used to query a cluster of semi-stcutured documents stored in the repository.

The query language provides access to all components of a semi-structured document, including the data, the descriptive tags, and the metadata.

Typically, although not necessarily, queries written in the query language have the general structure SELECT result FROM domain [WHERE condition].

SELECT result defines the target result. Specifically, result represents one or more result elements.

FROM domain specifies the document collection(s) and document fragments that should be filtered.

WHERE condition specifies a filter that should be applied to the results of the FROM expression.

Queries may take both path expressions and simple variables as input.

The following example query searches for citations of Bill Clinton extracted from paragraphs containing Hillary or wife:

| | | | |
|---|---|---|---|
| SELECT | citation | | |
| FROM | doc | IN | newDocuments |
| | | UNION | oldDocuments, |
| | paragraph | IN | doc//paragraph, |
| | citation | IN | paragraph/citation |
| WHERE | citation//who | | CONTAINS |
| “Bill Clinton” | | | |
| AND | | | |
| | paragraph | | CONTAINS |
| (\| “Hillary” “wife”); | | | |

Semantic support built into the query mechanism for stemming, usage of dictionary and thesaurus.

The stemmer provides the following default stemming services, among others:

transforms all words to upper-case;

removes all accents;

replaces all non-alphanumeric characters by spaces;

detects compound words;

Should the user require custom stemming services, the Store provides; the ability to create a custom stemmer via an API.

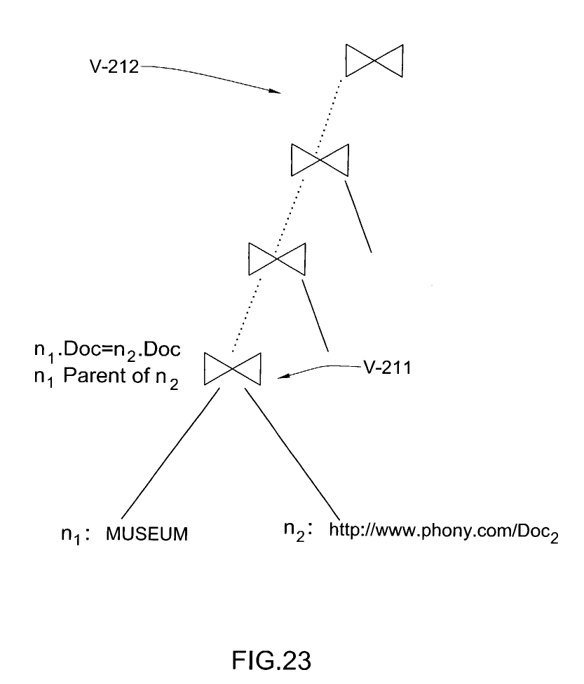

For a better understanding of the foregoing, there follows a detailed description of one possible implementation of store module 13, and information delivery module 14 (with reference to FIGS. 5 to 23) which, as will be evident from the description below (with reference to one embodiment of the invention as disclosed in U.S. patent application Ser. No. 10/082,811 entitled “Views in a large scale semi-structured repositories” filed Feb. 25, 2002, whose contents in its entirety is incorporated herein by reference) is composed of a plurality of sub modules not necessarily residing in the same physical location. Note that in the example below, queries are expressed in terms of Query trees, being one form of the more general SELECT FROM WHERE query representation.

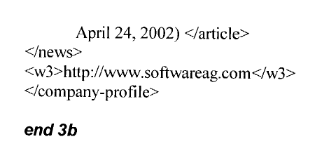

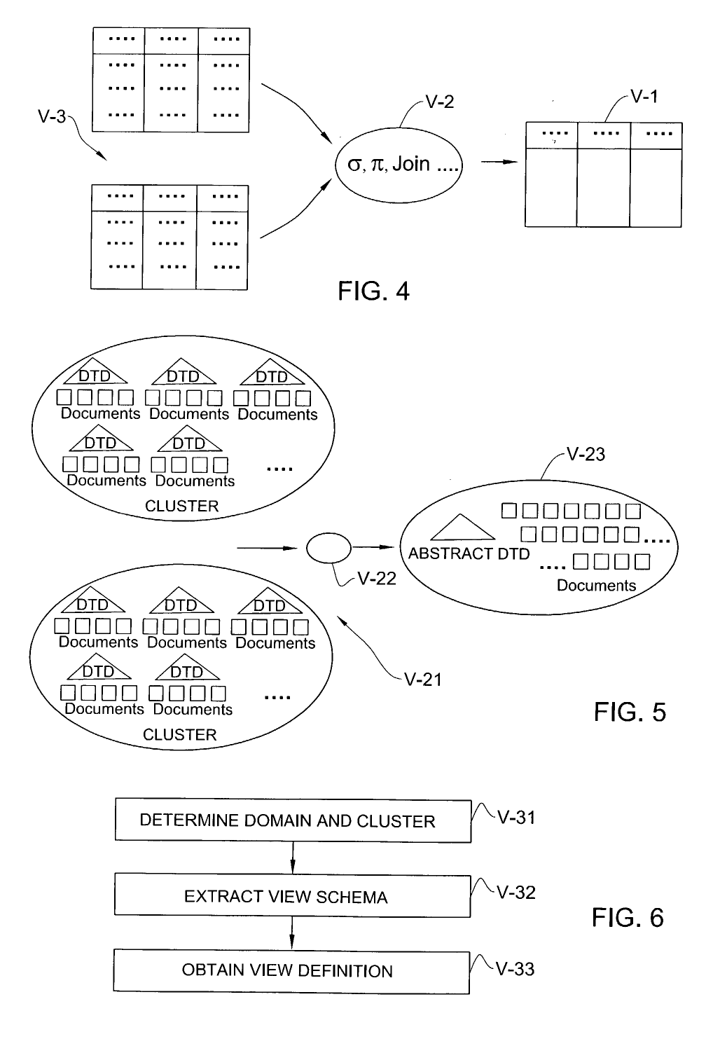

Views (see V-1 in FIG. 4) are used for querying and are well known, e.g. in the context of relational databases.

Generating views for semi-structured data in general, and XML documents in particular is considerably more difficult than for structured data due to the heterogeneous nature of the semi-structured data (XML documents), discussed in detail above. Insofar as the Web is concerned, the challenge is even more complicated considering the ever-increasing size in information available on the Internet. Thus, for a domain of interest, there are typically numerous (and an ever-increasing) number of XML documents with many different structures, and all should be encompassed by the same (or only few) views.

Note that whereas, for convenience, the discussion below is focused on XML documents (as a non limiting example of content elements) in the context of the Internet, the invention is not bound by any specific Markup Language documents and, in fact, is applicable to any semi-structured documents. Likewise, the use of the invention is not limited to the Internet only.

Note that the documents discussed herein were subjected to the loading and enrichment operations as described above, with reference to FIG. 1. These documents, may further be subjected to on-going enrichment activities, as discussed in detail above.

Views for semi-structured data concern combinations of several concrete document structure summaries of XML documents into one or more abstract structures of concepts. Note that for convenience, the description below focuses on specific examples of document structure summaries, a so called concrete Document Type Definition (DTD), and a specific example of abstract structure is of concepts, a so called abstract DTD. The invention is, by no means, bound by these examples.

Thus, and as shown in FIG. 5, several concrete DTDs (designated collectively as (V-21)) of several respective semi-structured documents are combined (V-22) (in a manner discussed in greater detail below) into an abstract DTD (V-23). The clustering of the concrete DTDs will be discussed in greater detail below.

By one embodiment, a view includes the following view elements: domain, schema and definition.

The domain is a collection of documents. To improve the system efficiency, these documents are clustered semantically and thus refer in the sequel to a set of clusters, each cluster being a collection of semantically related documents. The clusters that are part of the domain can be further organized in sub-clusters, eventually, where the domain is a set of clusters that can be regarded as a collection of semantically related documents, e.g. the cluster art refers to all documents that relate to art.

Note that the documents, after being loaded and selectively enriched (e.g. converted to an XML form in the manner specified) are assigned to the distinct clusters in either a manual fashion or using automated or semi-automatice known per se classification means. Note also that the documents that are stored in accordance with this embodiment may be periodically or otherwise furhter subject to enrichment utilities using e.g. the enrichment task mechanism described in detail with reference to FIG. 3 above. These documents, may further be subjected to on-going enrichment activities, as discussed in detail above.

Bearing this in mind, it should be noted that the terms domain and cluster should be construed in a broad manner. Thus, for example, depending upon the particular application, a cluster is a distinct cluster; few sub-clusters arranged, typically although not necessarily, in hierarchical fashion, etc. Any other organization of the documents within the view domain can be considered.

The schema of a view is a structure that is used to query the view. It consists of one or several abstract structure of concepts (e.g. abstract DTD).

The view definition is a mapping from view schema to view domain as will be discussed in detail below.

Turning now to FIG. 6, there is shown a flow chart of the general operational steps involved in the creation of a view, in accordance with an embodiment of the invention. In a first, known per se, step (V-31) (applicable also to relational databases), the domain(s)/cluster(s) are determined by finding out which data is of interest to the user, i.e., all clusters containing some data of interest. Now, it is required to understand how the user (who eventually issues the query) plans to use/query it. From this information, the schema is determined (V-32), e.g. abstract DTD. This can be implemented in an empirical manner (as is often the case for small applications), and/or by using a known per se database design tools.

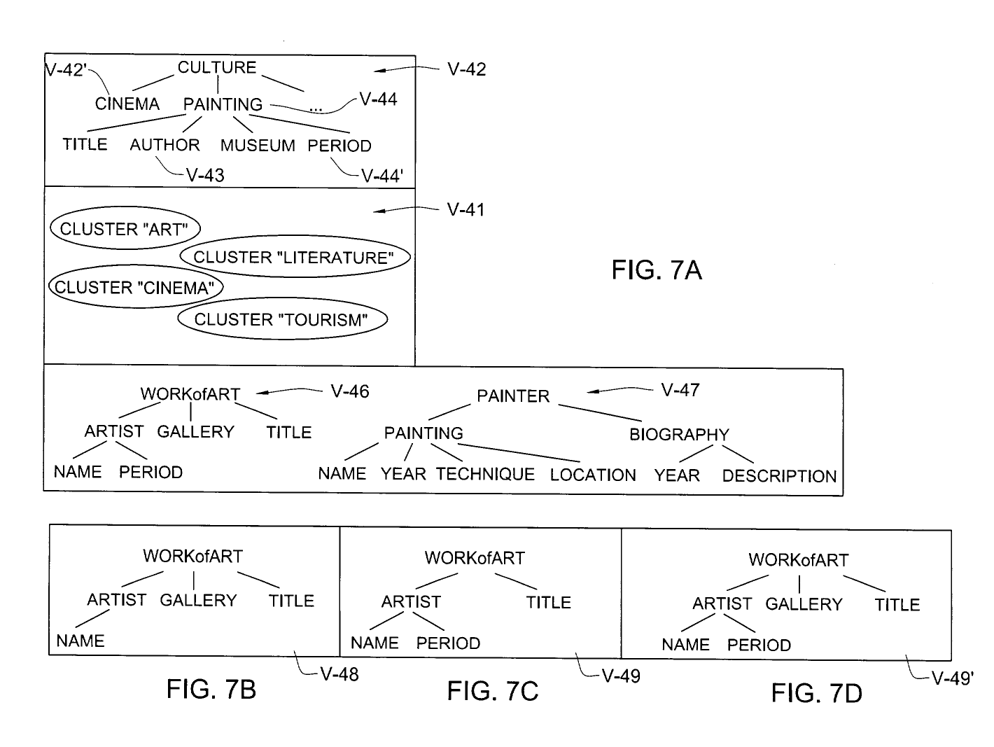

For a better understanding of the view elements (in accordance with an embodiment of the invention), attention is drawn to FIG. 7A illustrating, schematically, exemplary view element for the culture domain. As shown, the domain culture V-41 includes four clusters: art, literature, cinema and tourism (i.e. by this example the domain includes a set of four clusters), which were determined, e.g. in accordance with step V-31 above. The abstract DTD 42 (step V-32, above), is a tree of concepts describing abstract documents, i.e., those that are within the view. For instance, in the abstract DTD 42, internal nodes represent concepts, leaf represents a property, and a link represents a composition relationship between two concepts. Thus, for example, the link author V-43 under painting V-44 may be interpreted as painter, while author under movie as director (not shown). Note that the specified interoperation of the abstract DTD components is for clarity only and is by no means binding. The invention is of course not bound by the abstract DTD of FIG. 7A, and a fortiori, not by a tree structure.

FIG. 7A further illustrates two concrete DTDs rooted by WorkofArt V-46 and Painter V-47, both of which fall in the cluster art. Each concrete DTD V-46 or V-47, represents, in a simple manner, the structure of possibly many XML documents (not shown). Notice that the concrete DTDs are represented as trees. This representation is not binding, e.g., they may actually be graphs and as is known per se, it is always possible to replace a graph DTD structure by a forest of tree-like DTDs.

An exemplary procedure for constructing a concrete DTD from XML documents, will be described below, with reference to FIGS. 7B-D. Note the XML documents are provided, e.g. by collecting them from various Internet sites using known per se crawling techniques and/or received as input from other sources (e.g using the acquisition module discussed with reference to FIGS. 1 and 2), all as required and appropriate. Before proceeding, note that what is called concrete DTD is a simplification of the known XML DTD. According to the XML standard, all documents do not have to conform to an XML DTD. As will be explained in the sequel, concrete DTDs are constructed from document instances and it is thus possible to construct one concrete DTD to represent all documents that do not have an XML DTD. The procedure of constructing the concrete/XML DTD (therefore generating schema to the data) illustrates how data that is originally devoid of schema (when stored on the source repositories) can be nevertheless treated in a CWH of the invention. This procedure of constructing schema to “schema-less” data is obviated in conventional data warehouses, since, as recalled, structured data that is loaded to conventional DWH is inherently associated with schema.

Bearing this in mind, there follows a description of a procedure for extraction of concrete DTDs from the XML documents with reference also to FIGS. 7B to 7D.

Thus, each document instance of an XML DTD “d” contributes to the concrete DTD of “d”. At the beginning, the concrete DTD is empty. Then, each time a document is loaded (say XML document V-48 of FIG. 7B), its contribution to the concrete DTD is computed.

For instance, consider the following XML DTD:

<!ELEMENT WorkOfArt (Artist, Gallery?, Title)>
<!ELEMENT Artist (Name, Period?)>
<!ELEMENT Name (#PCDATA)>
<!ELEMENT Period (#PCDATA)>
<!ELEMENT Gallery (#PCDATA)>
<!ELEMENT Title (#PCDATA)>

Now, assume that the following document is loaded:

<WorkOfArt>
<Artist>
<Name> Rodin </Name>
</Artist>
<Gallery> Museum Rodin </Gallery<
Title> Le Baiser </Title>
</WorkOfArt>

While parsing it, a structure tree is constructed by memorizing all its elements/attributes and their relationship (V-48 in FIG. 7B). Note that some elements of the XML DTD are not part of this tree (e.g., Period). Note also that only those elements that are part of the parsed document are kept. Once the parsing is over, since the document was the first to be loaded for this particular DTD, the in-memory tree becomes the concrete DTD and is stored as such. Now, assume that a second document is loaded with the same XML DTD, e.g.,

```
<WorkOfArt>
  <Artist>
    <Name> Pagava </Name>
    <Period> 1907-1988 </Name>
  </Artist>
  <Title> La Jerusalem Celeste </Title>
</WorkOfArt>
```

Again, a structure tree (V-49 in FIG. 7C) is constructed. The new concrete DTD is then obtained by merging V-49 with the previous one (i.e., V-48). This results in V-49′ as shown in FIG. 7D.

Note that other procedures may be used in order to extract concrete DTDs from the XML documents, and the invention is not bound by the specified example.

Having described the concrete DTDs and the manner in which they are generated (from XML documents), attention is drawn again to FIG. 6 and in particular to step V-33. As may be recalled, steps V-31 and V-32 dealt with the definition of domain/clusters and abstract DTD. Step V-33 concerns view definition. In a preferred embodiment, the view definition is a mapping or mappings between the abstract DTD (one or more) and concrete DTDs, and it normally requires to determine the semantic similarities between elements in the concrete DTDs and nodes in the abstract DTDs.

The construction of mappings can be carried out in a semi-automatic procedure, using computerized tools and/or known techniques, described, e.g. in C. Renaud, J. P. Sirot, and D. Vodislav Semantic Integration of XML Heterogeneous Data Sources. In IDEAS, Grenoble, 2001.

An exemplary semi-automatic procedure is briefly described as follows: The mapping generation tool takes two inputs: an abstract DTD and a set of concrete DTDs and generates one output: a set of mappings between paths in the abstract and concrete DTDs.

By this example, mappings are generated through two intertwined steps:

1) Tags are mapped to tags. This implies two families of algorithms: (i) syntactical to take into account composed (e.g., workOfArt) or abbreviated words (parag for paragraph) and (ii) semantic, in order to take into account synonyms and related words (e.g., work of art and painting or statue). Note that (ii) relies on a dictionary.

2) Paths are mapped to Paths. Given any couple of concrete and abstract paths e.g., cp=ct1/ct2/ . . . /ctn, and ap=at1/at2/ . . . /atm), such that ctn is mapped to atm, cp is checked where it can be matched with ap. To this end, contextual information (provided as an input) is utilized. By a specific example, the contextual information includes markings of some nodes in the abstract DTD as context dependent. For example, the node title in the abstract DTD needs the context of painting to be interpreted. This means that a path ct1/ct2/ . . . /title is not considered as a possible match for painting/title unless some cti is mapped to “painting”. In other words, a movie title will not be associated to a painting title. In contrast, the abstract node museum has a meaning by itself. Thus, it will be possible to, e.g., match painting/museum with sculpture/museum. Note that the translation algorithm will consider this mapping if and only if painting is not a significant word for the query. i.e., there is no condition on painting and the user does not want to retrieve the painting element.

The specified semi-automatic procedure describes exemplary path-to-path mappings, i.e. mapping between path or paths in the abstract DTD to path or paths in the concrete DTDs.

By one embodiment, a view definition includes mappings defined by a set of pairs p,p′, constituting a mapping pair, where p is a path in the abstract DTD and p′ a path in some concrete DTD. Naturally, these paths are called abstract and concrete, respectively. Note that each abstract path p can be associated with one or more concrete paths p′ in one or more DTDs.

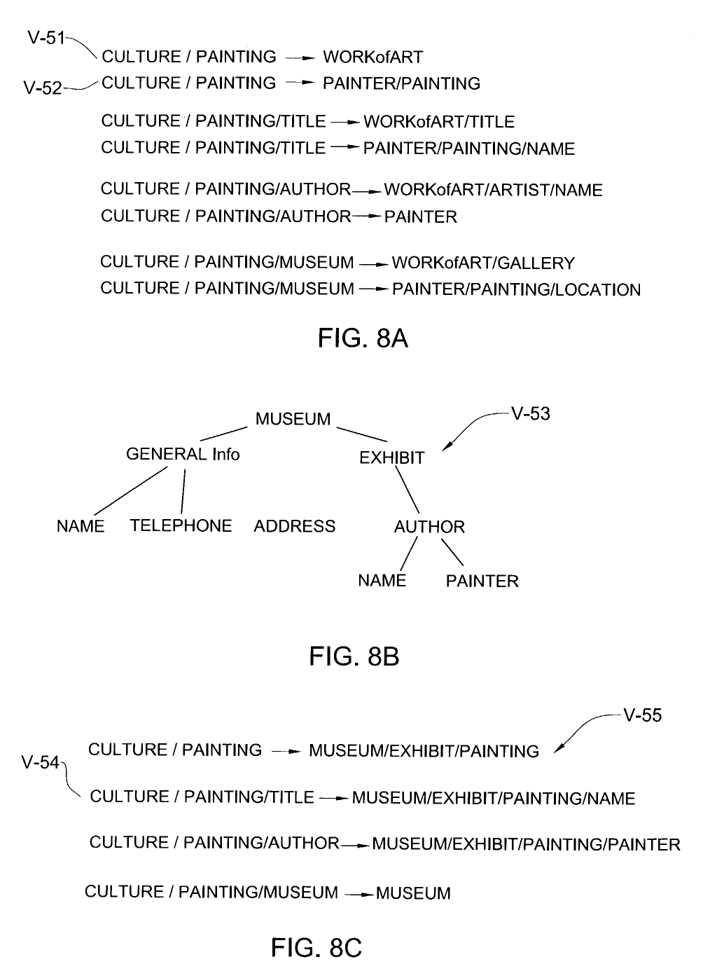

For a better understanding of the foregoing path to path mapping, attention is drawn to FIG. 8A illustrating an exemplary set of path-to-path mappings in connection with the specific examples of concrete DTDs and Abstract DTDs, illustrated in FIG. 7A. Note that the mappings of FIG. 8A all relate to the cluster art that is part of the culture domain (see V-41 in FIG. 7A). These mappings as forming sub-view mappings. FIG. 8C shows mappings for another sub-view that all relate to the cluster tourism (forming another sub-view mappings of the culture domain V-41). The latter mappings concern the concrete DTD 53 shown in FIG. 8B.

The sub-view mapping implementation, as will be explained in greater detail below, enables structured querying of XML documents irrespective of the number of different structures (of the semi-structured documents). An example is a Web scale number of structures (i.e. of XML documents stored in the Web).

Turning now to V-51 in FIG. 8A, it indicates that the abstract path culture/painting in abstract DTD 42 is mapped to concrete path Workof Art in concrete DTD 46, and, likewise, V-52 in FIG. 8A, indicates that the same abstract path culture/painting in abstract DTD 42 is mapped to concrete path painter/painting in concrete DTD 47.

Note that each instance must be interpreted independently, i.e., the fact that a/b/c is mapped to a′/b′/c′ does not mean that a/b is mapped to a′/b′. Consider, for instance, the following example: suppose that culture/painting/museum (abstract path) is mapped to artisticWorks/exhibition/address concrete path (not shown in the Figs). This mapping simply states that the abstract concept describing the location of paintings is closely related to the one describing where exhibitions take place. It does not entail that paintings and exhibitions (i.e. the respective prefixes) are the same thing. Also, note that some intermediary nodes within a path are not always relevant and can be omitted by considering ascendant/descendant relationships rather than parent/child one. E.g., the mapping from culture/painting/museum to artisticWorks/exhibition/address could be replaced by one from culture/painting/museum to artisticWorks//address where “//” stands for artisticWorks ‘is an ascendant of’ address

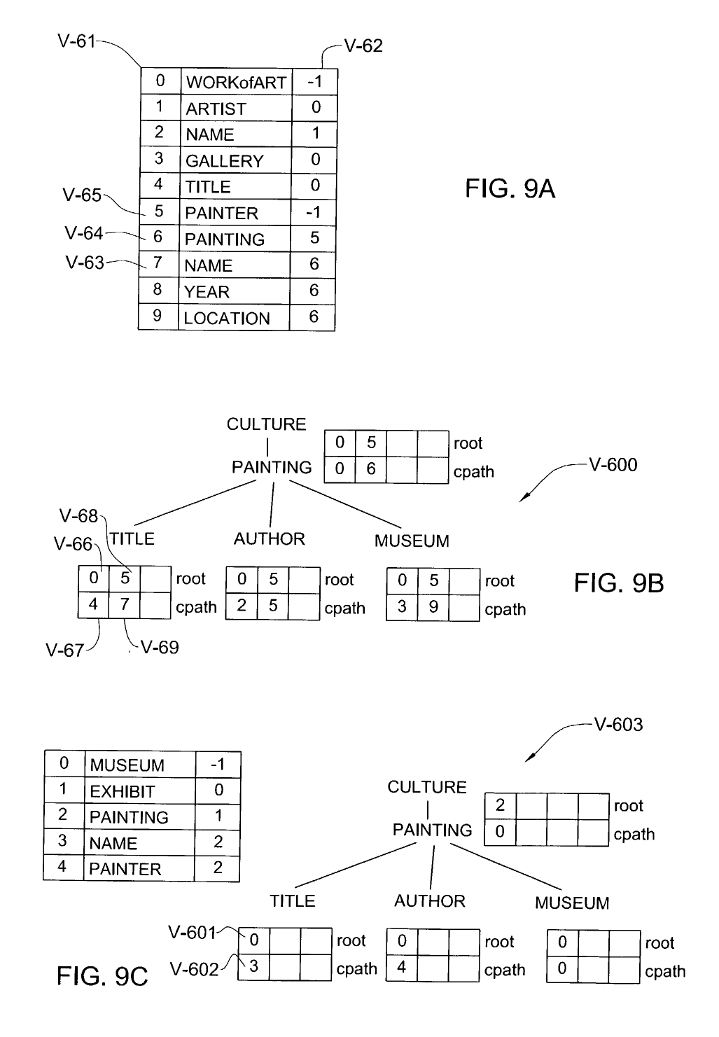

There follows now a description of a specific implementation of the path-to-path mappings with reference to FIGS. 9A and 9B. For clarity, the realization described with reference to FIGS. 9A and 9B corresponds to the representation of the mappings given in FIG. 8A and the abstract and concrete DTDs of FIG. 7A. Thus, the table of FIG. 9A, represents in a simple way the forest of all concrete paths that have been mapped to some abstract paths. Each node is represented by its table entry number (col. V-61) and the identifier of its father (col.V-62, −1 when it is a root). For instance, name (entry 7, 63) identifies painter/painting/name since it identifies its father 6 in column V-62 (i.e. painting 64 in entry 6). Painting, in its turn, identifies its father 5 in column V-62 (i.e. painter 65 in entry 5). Painter is the root since its father is −1 in column 62, therefore giving rise to painter/painting/name.

The tree (FIG. 9B) maps abstract paths to concrete paths. Concrete paths are represented in the tree by two integers identifying, respectively, the concrete path itself (cpath) and the DTD root element from which it stems (root).

Consider, for example, the entry (0,4) (V-66 and V-67, respectively) associated with the concept title (i.e. with the abstract path culture/painting/title). The root is identified by 0 (i.e. WorkofArt in entry 0 in the table of FIG. 9A) and the leaf is identified by 4 (i.e. title in entry 4 in the table of FIG. 9A). Wandering in table 9A from leaf to root in the manner described above would give rise to the concrete path WorkofArt/title forming part of the concrete DTD 46 in FIG. 7A. Similarly, the other entry (5, 7) (V-68 and V-69, respectively) associated with the same concept title would lead to concrete path painter/painting/name in concrete DTD 47 in FIG. 7A. The rest of the mapping instances in the tree of FIG. 9B are realized in a similar fashion. FIG. 9B concerned mappings within the art cluster.

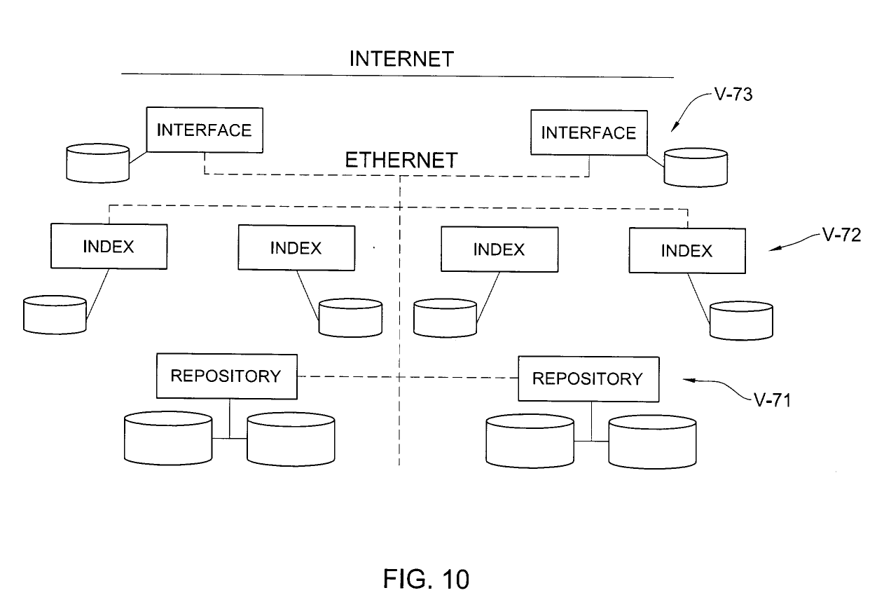

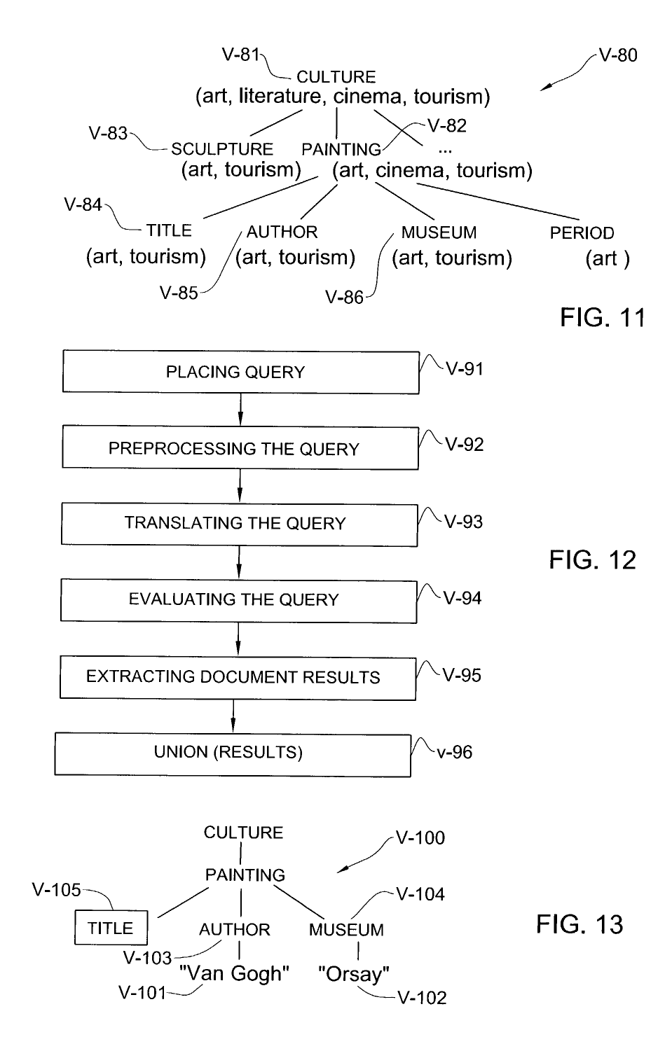

FIG. 9C shows the mappings implementation of the tourism cluster. For example, the entry (0, 3) (V-601 and V-602, respectively) is associated with the concept title (i.e. with the abstract path culture/painting/title). The root is identified by 0 (i.e. Museum in entry 0 in the table of FIG. 9C) and the leaf is identified by 3 (i.e. name in entry 3 in the table of FIG. 9C). Wandering in table 9C from leaf to root in the manner described above would give rise to the concrete path Museum/exhibit/painting/name forming part of the concrete DTD V-53 in FIG. 8B. The resulting mapping instance culture/painting/title−>Museum/exhibit/painting/name V-54 indeed appears in the sub view V-55 of FIG. 8C. (see FIGS. 8B-C for the corresponding concrete DTD and set of mappings). Note that the actual realization of the mappings takes into account cluster considerations, as will be discussed in more detail with reference to FIGS. 10 and 11, below.

Note that updates of sub-views are performed preferably off-line. One possible manner of performing an update is to send a message to a global view server with: (i) the name of the view and (ii) a file containing the new mappings. The global view server will be responsible for computing the new representation and replacing the non updated view, with an updated one. The update frequency and procedure may be determined, depending upon the particular application, taking into account factors such as load, the extent of use of the existing view, time from last update, and or others. Other manners of conducting updates are, of course, applicable.

Having described the views and sub-views constructions, in accordance with few embodiments of the invention, there follows a description, with reference to FIG. 10, of a pertinent non-limiting system architecture which will utilize the specified views and sub-views for structured querying purposes. Note that the store module 13 and information delivery module 14 (of FIG. 1) are simplified representation.

Generally speaking, in accordance with this embodiment, three types of machines are utilized. Plurality of Repository machines (RM) (designated collectively as V-71), are in charge of storing the Semi-structured documents and their associated concrete DTDs. Data is clustered according to a semantic classification, such that each RM stores one or potentially several clusters of semantically related data (e.g., all documents related to the clusters art and literature). By this embodiment, the documents are collected from the Web, using, known per se, crawling techniques (or, e.g. provided through other means, such as the acquisition module 13 discussed with reference to FIGS. 1 and 2) and the extraction of corresponding concrete DTDs and association with clusters is realized in a manner described above. The fact that documents that are stored in the same repository machine are associated with a common cluster (or limited number of clusters) results in a reduced number of machines that have to be accessed to evaluate a particular query. The invention is, of course, not bound by the specified configuration of repository machines.

Index machines (XM), referred to collectively as V-72, have by this embodiment large memories that are mainly devoted to indexes as well as to one or more sub-views that are associated with one or more clusters. Thus, for example, a given index machine stores the index and sub-view for the art cluster (see FIGS. 9A and 9B), and a different index machine stores the index and sub-view for the tourism (see FIG. 9C). The structure of the indexes and how there are used during query processing, will be discussed in greater detail below. Note that whilst this is not obligatory, for efficient implementation it is advantageous to store the index and the associated sub-view in the same machine.

In accordance with one embodiment, each RM machine stored documents of a common cluster, and each XM stored the index and the sub-view of a common cluster and there is a one-to-one correspondence between an XM machine and the RM machine of a respective cluster. Reverting to the former example, this would imply that there is an RM machine that stores the concrete DTDs for the art cluster, e.g. V-46 and V-47 of FIG. 7A, as well as their corresponding XML documents (not shown), and there is a counterpart index machine that stores the sub-view mappings for the art cluster (V-600 in FIG. 9B) as well as the pertinent index, and, by the same token, another RM machine stores the concrete DTD V-53 for tourism (and its associated XML document) and its corresponding index machine stores the sub-view V-603 in FIG. 9C for tourism and its pertinent index. Whilst this has been given for illustration only, and the invention is, by no means, bound by this arrangement, such an exemplary architecture (i.e. one to one correspondence between XM machine and RM machine) would expedite the query processing phase, as discussed in detail below.

By one embodiment the clusters are partitioned on index machines so as to guarantee that (i) all indexes reside in main memory and (ii) each XM is associated to only one RM.

Note that the size allocated to a sub-view on an index machine is very small compared to the size of the index itself (usually less than a thousandth). Also, the size of a view depends on the size and heterogeneity of clusters. Note, thus, that if the index is stored in the main memory, the latter would normally accommodate also the sub-view bearing in mind that the sub-view is considerably smaller than the index.

When a cluster becomes too big, the classification can be refined so as to split it. This results in a re-organization of store and indexes that is performed while (re-)loading views, as discussed above. Views are reconstructed when the index re-organization is over. In the meantime, views are simply larger than they should. Here also, the invention is not bound by the specified procedure of re-organizing indexes.

Turning now to interface machines (designated collectively as V-73), in the case of Internet application, they are typically (although not necessarily) nodes in the net. Interface machines run the structured query applications, compiling queries and are responsible for dispatching tasks/processes to the other machines, all as discussed in greater detail below. Typically, they all use the same global information, e.g. abstract DTDs and the set of pertinent clusters (such as V-41 and V-42 in FIG. 7A). Note that whereas the number of RMs and XMs depends on the warehouse size, the number of interface machines grows with the number of users.

An Integration of an abstract DTD and clusters in the interface machine is illustrated, schematically, in FIG. 11, in the form of annotated abstract DTD (V-80). More precisely, each node is marked with the clusters in which there exists at least one matching concrete path.

The construction of annotated abstract DTD is relatively straightforward. Any abstract path that has a counterpart mapped concrete path in a given cluster will be assigned with the specified cluster name. The sub-views mappings, discussed above, will serve for determining whether a given abstract path is mapped to a concrete path in the specified cluster. For example, all the concepts of the abstract DTD of FIG. 11, are associated with the cluster art, meaning that each and every abstract path in the abstract DTD (V-80) has at least one mapped concrete path in a concrete DTD that belong to the cluster art. In contrast, the cluster cinema is associated only with the concepts culture and painting (V-81 and V-82, respectively), suggesting that culture and culture/painting have counterpart concrete paths in concrete DTDs that belong to the cinema cluster. Note that sculpture V-83, for example, is not associated with the cinema cluster, meaning, thus, that the abstract path culture/sculpture does not have any counterpart mapped concrete path in a concrete DTD that belongs to the cluster cinema. These characteristics will be used for expediting the processing of structured queries, as will be discussed in detail, below.

By a preferred embodiment, the annotated abstract DTD is replicated because, each interface machine is, preferably, able to pre-process all queries. Note that the annotated abstract DTD structure is not binding and it could have been made smaller by keeping, say, only the root of the abstract DTD. However, as it is, it allows to (i) check the abstract “typing” of queries and (ii) reduce the number of plans (e.g., if the user is interested in titles of paintings, there is no need to generate a plan over the cinema cluster, since title V-84 is not associated with cinema); These characteristics will be discussed in more detail below, in connection with the query processing phase.

Note that by a preferred embodiment, interface machines manage only abstract DTDs and their associated clusters, two items whose size is usually rather small and very much controlled.

Those versed in the art will readily appreciate that any of the repository machine, index machine and interface machine is not limited to any hardware/software configurations. They should be regarded as logical processes, tasks, or threads that can be implemented in the same physical machine or by another non limited embodiment on task devoted machines, as discussed above, i.e. each of the repository, index and interface machines performs its designated task. Physical machine should be construed in a broad manner including, but not limited to, P.C., a network of computers, etc.

The preparatory phase includes the construction of view(s) in the manner specified above, and construction of index(s) that will be discussed in greater detail below. There follows now a description of the subsequent structured querying phase. FIG. 12 illustrates a generalized flow diagram of a structured query processing steps, in accordance with one embodiment of the invention. Note that the querying phase is described with reference to the architecture implementation of FIG. 10. The invention is by no means bound by this implementation.

Thus, a typical querying sequence includes:

placement of a query using an interface machine user-interface (V-91), pre-processing (V-92) the query at the interface machine against, say, the annotated abstract DTD of FIG. 11, giving rise to query induced abstract DTD (referred to also as abstract query plan). At this stage, the query plans are called abstract since they refer to abstract DTDs. The query plan is then split into sub-plans, one per index machine and communicated to the respective index machines. Each communicated sub-plan is translated (V-93) (at the respective index machine) into concrete sub-plan (referred to also as query-induced concrete DTD), that are evaluated (at the same index machine) using the index in order to identify the documents (or portion thereof) that match the query sub-plans (V-94). Note that the terms query abstract plan (sub-plan) and query-induced abstract DTD are used interchangeably, and this applies also to the terms query concrete plan (sub-plan) and query-induced concrete DTD. Having identified the documents, or portion thereof, that meet the query, they are extracted from the corresponding repository machine (V-95).

The results obtained from the one or more repository machines are subject to union in the interface machine (V-96).

Turning, at first, to step (V-91), the user places a query. For simplicity, assume that the user interface for placing queries is the abstract DTD (V-42) of the specific example described with reference to FIG. 7A. If the user is interested in the title of Van Gogh paintings in the Orsay museum, she would fill-in the sought details in the relevant nodes of the abstract DTD interface and an abstract query tree (V-100) (of FIG. 13) is calculated. Note, that concepts in the abstract DTD (such as cinema V-42′ or period V-44′ in FIG. 7A) that do not form part of the query will not be included in the query tree V-100. Note also, that the sought values Van Gogh and Orsay (V-101 and V-102) were added as leaves to concepts author and museum (V-103 and V-104, respectively). The sought title is identified by rectangular V-105. Note that query tree is one form of the generalized SELECT result FROM domain [WHERE condition] query representation, discussed above.

The invention is, of course, not bound by the specified interface and any other interface is applicable. The invention is, likewise, not bound by the generated tree or tree like abstract queries and, accordingly, queries of more expressive power may be utilized, all as required and appropriate. Moreover, the latter query illustrates only one possible structured query. The invention embraces a wide range of possible structured queries supported by Xquery or other suitable query language. By a preferred embodiment, a pre-processing step is then carried out in the interface machine (step V-92), resulting in query induced abstract structure of concepts (by way of example query induced abstract DTD, discussed below), and a second processing step in one or more index machines. By a preferred non-limiting embodiment the processing step in the index machine is divided into translation step using the respective sub-view or sub-views and evaluation using the corresponding index, all as discussed in greater detail below. As will be further noted below, the distinction into these processing steps has some important advantages, as will be discussed in a greater detail below.

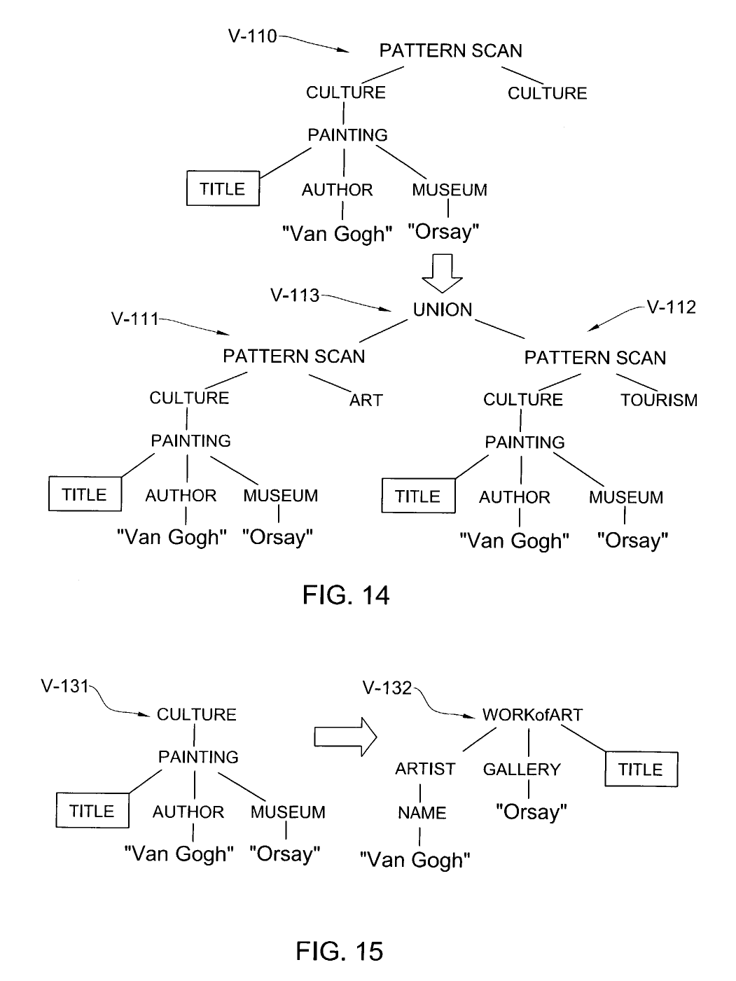

Turning, at first, to the interface machine pre-processing (step V-92), the pertinent input and output data are illustrated in FIG. 14. Note that the input (V-110) is a query plan figuring one operator named PatternScan. The PatternScan operator has two inputs: a cluster and a pattern tree. Intuitively, the role of this operator is to match the documents within the given cluster against the given pattern tree. All the documents that match will contribute to the result, the others will be discarded. This is explained in more details below, with reference to steps V-94 and V-95. Reverting now to FIG. 14, in V-110, the cluster is the abstract cluster culture and the pattern tree is the query tree of FIG. 13. The goal of step V-92 is to decompose the query against the abstract cluster into a union of sub-queries against concrete clusters. Bearing in mind that the sub-views (that eventually lead to concrete DTDs) are organized in the index machines by clusters, the next natural action will be to send these sub-plans to the concerned index machines. This will be discussed in greater detail below.

As an example, consider the query plan V-113 in FIG. 14 which corresponds to plan V-110 where the query against the abstract cluster culture has been decomposed into two sub-queries against the concrete clusters art and tourism. Before explaining why these two clusters have been selected, the transformation per se will be explained. The one PatternScan operation has been replaced by a union of two PatternScan operations over, respectively, the art (V- 111) and tourism (V-112) clusters. Note that the pattern tree of V-110 has not been changed in both V-111 and V-112. Note that for clarity when referring to the PatternScan operation, the term “tree” (such as query tree, abstract tree, etc), will be referred also as pattern tree.

Bearing this in mind, there follows now an explanation how the two concrete clusters were selected. Thus, only clusters containing mappings to all the paths in the query tree are considered in a query. By this specific example, this is achieved by intersecting the annotated tree (V-80) of FIG. 11, with the input query tree (V-110). The resulting clusters are art and tourism since, as readily arises from viewing the annotated tree V-80, these two clusters are assigned to every node (concept) of the query tree, i.e. culture, painting, title, author, and museum (see V-81 to V-86 in FIG. 11). The fact that every node in the query tree is assigned with the art concept signifies that every path in the query tree has at least one mapped path in a concrete DTD of the cluster art. By the same token, nodes V-81 to V-86 are, all, associated with the tourism cluster indicating that every path in the query tree has at least one mapped path in a concrete DTD of the cluster tourism. In contrast, the cluster cinema (see annotation tree V-80) will not be considered since there are nodes in the query tree (e.g. author V-85 and museum V-86) which are not associated with cinema. The same applies to the cluster literature. Bearing in mind that the sub-views (that eventually lead to concrete DTDs) are organized in the index machines by clusters, the next natural step would be to access the index machines associated with the art and tourism clusters for further processing. This will be discussed in greater detail below.

Once the query has been decomposed into a union of sub-queries, the sub-queries are sent to the index machines associated to their specific cluster (i.e. art and tourism) for further processing.

Note that the invention is not bound by the specific query induced DTDs examples discussed above. The invention is further not bound by the communication protocol between the interface machine and the index machine(s). Thus, by way of non limiting example, the resulting sub-queries can be broadcasted, and only the relevant index machine(s) will process them, whereas others will discard the received information.

Note that the invention is further not bound by the operating steps performed in the interface machine, as discussed above.

There follows now a description of the query processing operational steps V-93 (in FIG. 12) that is performed in an index machine, in accordance with one embodiment of the invention. In each of the index machines that received the query sub-plans (say the art index machine), the abstract pattern trees within the PatternScan operation are translated into concrete ones, using the appropriate sub-view that includes mappings from abstract paths to concrete paths. The process will therefore be called, in short, A2C, standing for abstract to concrete. The A2C process will be exemplified, with reference to the (input) abstract query pattern tree for art (the pattern tree within V-111 in FIG. 14, or the pattern tree V- 131 in FIG. 15, which is the same except for the fact that the designation of art cluster is removed) and an output concrete query pattern tree designated V-132 in FIG. 15. Note that the output query tree is obtained in connection with concrete DTD V-46 of FIG. 7A (i.e., the concrete DTD rooted WorkofArt).

The translation from abstract pattern query tree (termed more generally query induced abstract DTD) into concrete pattern query trees (termed more generally as induced concrete DTD) utilizes the mappings of the art sub-view, as will be illustrated below. Thus, the set of abstract paths and the set of concrete paths are presented, by this example, as respective abstract and concrete query tree.

The main problem of the A2C algorithm is due to the large amount of mappings associated to each path of the abstract DTD. For n nodes in the abstract query pattern, with k mappings for each node, A2C should examine k n possible configurations. In order to reduce the number of valid options, the following constrains are applied to the concrete paths that are mapped from an abstract path, i.e., the concrete paths must (i) belong to the same concrete DTD and (ii) preserve the descendant relationships of the query; the latter constraint will be explained in more detail. Note that the invention is neither bound by the specific A2C process described herein nor by the specified constraints.

First constraint PreserveAscDesc:

Let a1, a2 be nodes of an abstract pattern tree Ta, with a2 descendant of al, and c1, c2 their corresponding nodes in a concrete pattern tree Tc. Then Tc is a valid translation of Ta only if c2 is a descendant of c1.

This rule states that one cannot swap two nodes when going from abstract to concrete. Somehow, it implies that descendant is a semantically meaningful relationship that is not broken. This constraint can reduce the number of concrete queries captured by the query translation.

For instance, consider the path painter/painting in the concrete DTD V-47 of FIG. 7A, it will not be considered as an appropriate translation for the abstract path culture/painting/author since it reverses the relationship between painting and author (author is a child whereas painter is a parent).

When the rule is imposed, the complexity of the A2C algorithm is reduced. The estimated number of lost DTDs is very low in practice, where an efficient translation is relevant for users that are generally impatient to obtain results. However, in case of few answers this constraint can be relaxed, as discussed below.

In order to further reduce the complexity, a technical rule is imposed that may seem somewhat arbitrary but is rarely violated in practice.

Second Constraint NoTwoSubpaths:

Let V be a view defined by the set of path-to-path mappings M. Let (a>c) be in M and ap be a prefix of a. Then, V is valid only if there does not exist c1, c2 distinct prefixes of c such that: 1

(ap→c1) [symbol] M∩(ap→c2) [symbol] M

This means that a should not have an ancestor that is mapped to two different ancestors of c. In other words, there should be at most one solution to the mapping of nodes along an abstract path to nodes along some concrete path. Exceptions may exist but the rule is kept in most practical cases.

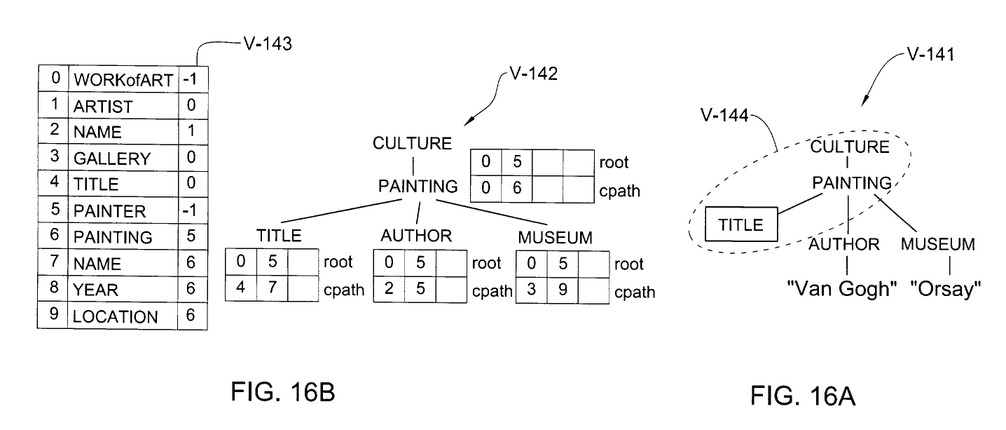

Bearing this in mind, there follows a description of the A2C algorithm, with reference also to FIG. 16A. Note that the query pattern tree (V-141) of FIG. 16A, is identical to the abstract pattern query tree (V-131) of FIG. 15, except for the designation of the left most path in dashed line (V-144).

Consider the leftmost path V-144 on the abstract query tree (V-141) of FIG. 16 (i.e. culture/painting/title). Rule PreserveAscDesc implies that the translation of this path to another path can be computed going up and Rule NoTwoSubpaths guarantees that, once the leaf mapping has been chosen, there is at most one solution.

This solution is constructed as follows: a concrete node is chosen for culture/painting/title (e.g., WorkOfArt/title), then upward analysis is performed and search the mappings of culture/painting among the prefixes of WorkOfArt/title, e.g. WorkOfArt.

To compute the translation of a whole tree, it is decomposed in upward paths starting from each leaf and stopping when a node that has already been visited by a previous upward path. For the leftmost path V-144, this implies starting the process from the leaf title, through painting to the root culture. The next processed path culture/painting/author in FIG. 16A would stop in painting and not in culture, since painting has already been encountered in the processing of the previous path (V-144). This node is called Upperbound.

The same applies to the last processed path culture/painting/museum in FIG. 16A, i.e. the upward processing stops at node painting instead of culture. Note that constants (i.e. Van Gogh and Orsay) in the query tree are ignored. As a matter of fact, although not illustrated here for simplicity, intermediate nodes that are not important to the query may also be ignored; i.e., nodes that are neither part of the result, nor needed to evaluate the predicates (the given example features none of these nodes).

FIG. 16B (V-142) is a reminder of the local sub-view structure in the index machine described above (with reference to FIGS. 9A and 9B). Once the decomposition has been performed, A2C translates each upward path to a concrete path, then it computes concrete DTD query pattern trees (e.g. the resulting concrete query tree V-132) by combining the concrete branch paths found for the various branches of the tree solutions as explained below.

As may be recalled, and as shown in FIG. 16B (V-142), the view stores for each node of the abstract DTD its mappings as a list of entries (root, cpath), where root identifies the concrete DTD and cpath is concrete path of the mapping. This list is sorted by root and then by cpath.

First, suppose that each leaf has at most one mapping for each root (which is the case in FIG. 16). Then the A2C algorithm computes the solution by finding compatible path solutions going from left to right, as follows:

1. The leftmost leaf L is the master leaf. In FIG. 16A, it corresponds to Node Title. It considers its mappings one by one, the other nodes in the abstract pattern remaining “synchronized”, i.e. the mapping that they consider at any time has the same root as L. The reason is that a concrete pattern tree solution must have the same root for all its nodes. For instance, suppose that a move is made from one mapping to the next in L (e.g., from (0,4) to (5,7) that are the two mappings associated to Node Title in V-142) and that, in so doing, a move is made from root_i−1 to root_{—i} (e.g., from 0 to 5). Then, all other nodes advance to their next root_{—i} mapping (e.g., (5,5) for Node Author, (5,6) for Node Painting, etc.).

2. Concrete paths are computed upward starting from their leaf (there exists at most one such path, as explained above). For each abstract node on the upward path, A2C looks for a mapping among those with the appropriate root and that is a prefix of the cpath already found for the node below it. E.g., if Mapping (0,4) for Title is considered, then Mapping (0,0) for Painting is accepted since (i) it has the same 0 root and (ii) 4 is a descendant of 0 (see Table V-143). Checking that a constant cpath is a prefix of another one is done in constant time using the concrete path table (V-143), i.e. typically, although not necessarily 1 or 2 table accesses, which is the difference of length between the paths. The paths other than the leftmost one (i.e. other than V-144) must contain the cpath concrete path that has been computed by some previous branch for their upperbound (if any). For instance, if the leftmost upward path in FIG. 16 found the mapping (0, 0) for painting, the upward paths of author and museum are constrained to find the same mapping when computing their concrete branches.

3. A solution is found when all upward paths have a concrete path solution. Then L goes to its next mapping e.g., (5,7) is considered (for Title) to search for a new solution, and so on, until all the mappings of L have been explored.

Now, suppose that there are more than one mapping for a given node and a root (e.g., whilst not shown in FIG. 16B, imagine that Author was also mapped to some WorkOfArt/SimilarWorks/Artist/Name). Note that this rarely happens. Then for each distinct root_i of L, all possible combinations of the pattern leaves root_{—i} mappings are checked (e.g., for Title (0,4) Author (0,2) and Author (0,X) are considered, where X is the number associated to WorkOfArt/SimilarWorks/Artist/Name). This implies some backward steps in leaf mappings (except for the master leaf L).

Note that an abstract query tree can be translated to many concrete query trees in the same index machine, depending inter alia on the number of concrete DTDs that are encompassed by the mappings of the specified index machine. Thus, for example, for hundreds of concrete DTDs that fall in the art cluster, there may be, for the art index machine, potentially hundreds of concrete query trees that are translated from an abstract query tree. Note that the two-step processing described above (i.e., the pre-processing in the interface machine described with reference to FIG. 14 and the translation in the index machine, described with reference to FIGS. 15 and 16) has some inherent advantages. For one, useless communication to the index machine is avoided, since only limited data is communicated from the interface machine to the index machine (i.e. a sub-plan, being one abstract query pattern tree). Also, the plans that are communicated from the interface machine to the index machine are small, i.e., they do not include the many instances of concrete patterns matching an abstract one. Put differently, the plans do not include the large mappings data required for calculating the resulting concrete query trees. The latter mappings will be dealt in the index machine. Moreover, only limited “global” information needs to be maintained on the interface machines, e.g., by this embodiment, this global data is the correspondence between abstract DTDs and clusters, illustrated in the annotated abstract tree of FIG. 11. The remaining view (large) information is naturally distributed over the concerned index machines. To summarize, insofar as the interface machine is concerned, only limited data is maintained, the processing of the query is relatively simple and the volume of communication transmitted to the index machine is small. Accordingly, the overhead (in terms of processing and space resources) imposed on the user interface machine is very limited and, yet, allowing her to query huge amount of semi-structured documents, irrespective of the number of different structures.

Having translated, in the index machine (step V-93 of FIG. 12), an abstract pattern query tree (e.g. V-131 of FIG. 15) to one or more concrete query pattern trees (e.g. V-132 of FIG. 15) there is a need to evaluate in the index machine (step V-94 in FIG. 12) the concrete query tree in order to identify which XML documents (documents/elements) match this query tree. An XML document that matches this pattern query tree, is requires to include all the nodes elements (e.g., in query tree V-132: WorkofArt, Artist, Gallery, Title, Name), and leaf value words (in query tree V-132: Orsay and Van Gogh) within the tree. Such an XML document is also required to maintain the hierarchy among the nodes as prescribed by the concrete query pattern tree.

As specified above, the pattern tree evaluation matching step (V-94 in FIG. 12) is carried out in the index machine that is associated with a given cluster. The resulting XML document(s) reside in a repository machine that is also arranged by clusters, and accordingly the index machine already knows to which repository machine it should communicate the results. Still, the concrete pattern query tree that is strongly related to a specific concrete DTD (e.g. concrete pattern tree query V-132 relating to concrete DTD V-46 in FIG. 7) is not necessarily identifying one specific document. This, as explained with reference to FIGS. 7B-D above, stems from the fact that a given concrete DTD may “describe” the structure of many, and possibly thousands or more of XML documents, and it is required to identify which document (or documents) from among these thousands match the concrete, query pattern tree.

By a preferred embodiment, the evaluation step is implemented in the index machine by using a full text index. One possible realization is by using a so-called pattern scan described herein with reference to a specific example. The invention is by no means bound by this specific indexing scheme or by the pattern scan realization.

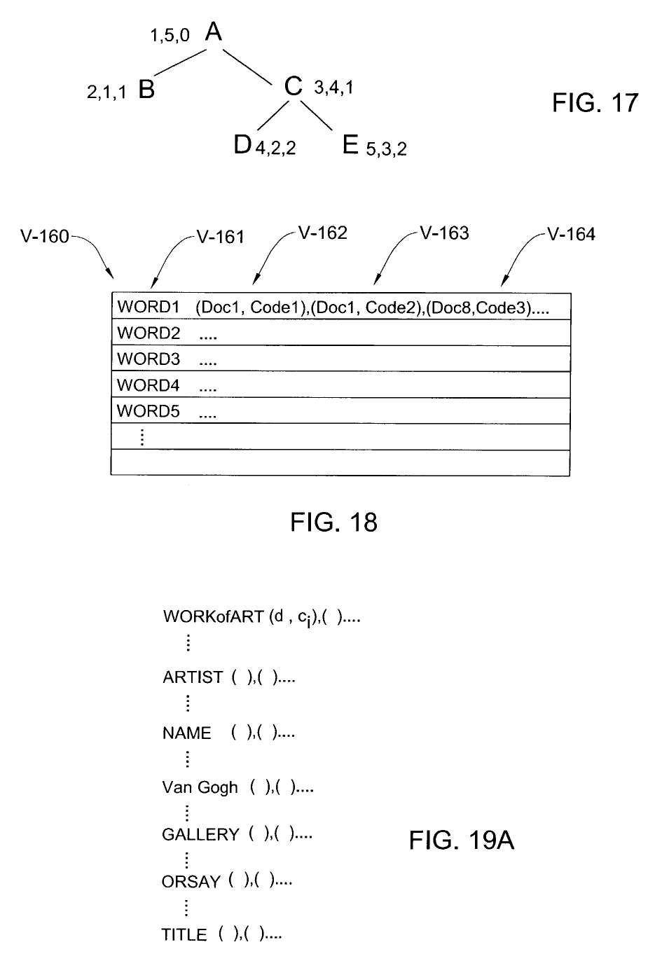

In order to answer structured queries such as “name” is a parent of “Jean”, or “person” is an ancestor of both “name” and “address”, a so called Dietz's numbering scheme is used, (exemplified with reference to FIG. 17 below) in accordance with one embodiment. More precisely, each word that is encountered in an XML document is associated with its position in the document relatively to its ancestor and descendant nodes. Note that this is performed as a preparatory step that precedes the actual query evaluation phase.

The position is encoded by three numbers that are designated pre-order, post-order and level. Given an XML tree T, the pre and post order numbers of nodes in T are assigned according to a left-deep traversal of T. The level number represents the level tree.

This encoding is illustrated in FIG. 17. Thus, the left number for each node is the pre-order number, i.e. signifying visit order of the nodes in left traversal of the tree, i.e. A,B,C,D,E, and accordingly, these nodes are assigned with pre-order numbers 1,2,3,4,5, respectively. The middle number represents post-order numbers, signifying the post order visit of the nodes, i.e. B,D,E,C,A and accordingly, these nodes are assigned with post-order numbers 1,2,3,4,5, respectively. The right number in the code is the level number in the tree, i.e. 0 for A, 1 for B and C, and 2 for D and E.

Bearing this in mind, the following conditions hold true:

n is an ancestor of m if and only if pre (n)<pre (m) and post (m)>post (n)

n is an parent of m if and only if n is an ancestor of m and level (n)=level (m)−1

By the index scheme of this embodiment, the preliminary encoding described with reference to FIG. 17, would assign for every word appearing in a document its code, and this applied to all the documents that belong to a cluster or clusters embraced by an indexing machine of interest. This procedure is performed for each index machine.

For a better understanding, consider, for example, the full index V-160 (FIG. 18) for the index machine storing a sub-view for, say the art. Word1, word2 and onwards are all the words appearing in one or more documents in the art cluster. Note that the term ‘word’ encompasses a leaf word (e.g., Van Gogh) or the name of an element (e.g., Painter). For each word, say word1, the index data structure includes pairs, each, designating a document and a code. Thus, word1 (V-161) is associated with three pairs, the first (V-162) indicates that Word1 is found in document no 1 (Doc1; note that Doc1 is in fact identifier specifying the location of this document in the repository machine), and that its code is code1 (i.e., the triple number code explained above, with reference to FIG. 17). Similarly, the second pair (V-163) indicates that the same word appears in the same document Doc1, however, in a different location—as indicated by code2, and the third pair (V-164) indicates that the same word appears in document no. 8 and at location identified by code3, and so forth. Note that the invention is not bound by the specific full index scheme, discussed above.

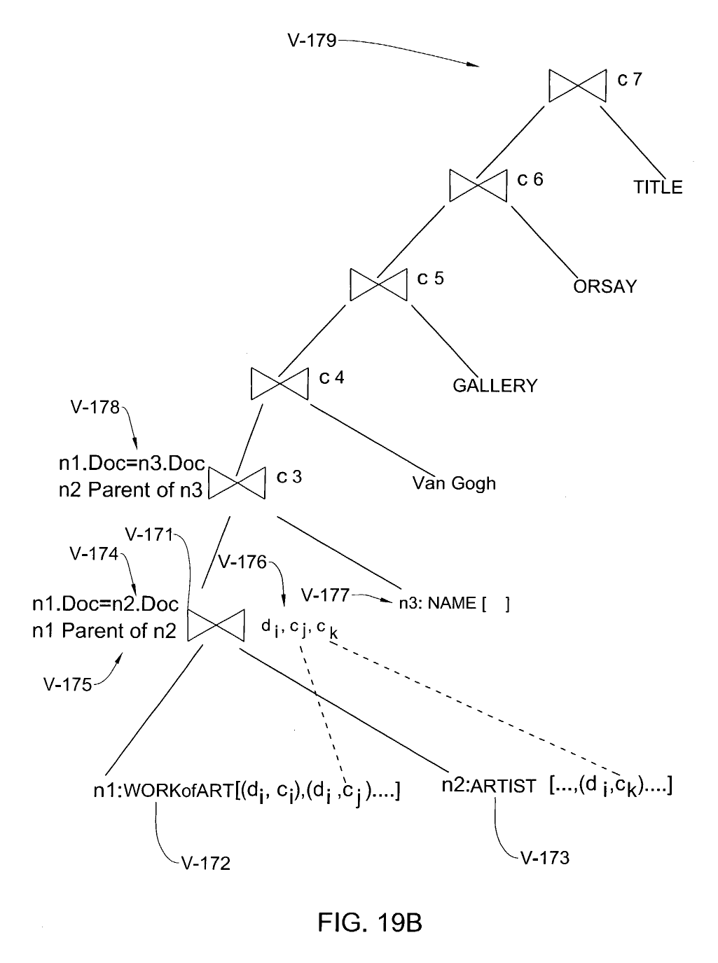

Attention is now drawn to FIGS. 19A-B illustrating a sequence of join operations, used in a query evaluation process, in accordance with an embodiment of the invention. Recall, that there is already available an index (see, e.g. FIG. 18) for all the words of semi-structured documents that fall, say, in the art cluster (assuming that the art index machine is where the query evaluation takes place). In particular, the index includes all the words of the query induced concrete pattern tree of the present example, i.e. V-132 of FIG. 15 (which, as recalled, belong to the art cluster). FIG. 19A illustrates the relevant entries in the index table that concern only the words of the query pattern tree V-132, each associated with pairs of document number (Di) and code (Ci). In FIG. 19A, the associated pairs are shown, for clarity, only in respect of WorkofArt. If there are more concrete pattern query trees (for the art cluster) that were translated from abstract query pattern tree, the evaluation process applies, likewise, to each one of them. For simplicity, the description below assumes that only one concrete query pattern tree V-132 of FIG. 16 was translated and is now subject to evaluation.

The goal of the query evaluation step is to find document or documents that include all the words and maintain the hierarchy prescribed by the query tree.

One possible realization is by using a series of join operations, shown in FIG. 19B. The invention is by no means bound by this solution. Taking, for example, the first condition, it is required that the words WorkofArt and artist appear and that the former is a parent of the latter. To this end, a join operation V-171 is applied to the pairs (di,cm) of WorkofArt V-172 (designated also as n1) and the pairs (dj,cn) of Artist V-173 (designated also as n2). Respective pairs of WorkofArt and Artist will match in the join operation only if they belong to the same document (i.e. n1.doc=n2.doc 174−) and n1 is a parent of n2 (V- 175). The former condition is easy to check, i.e. the respective pairs should have the same di member of the pair. The second, i.e. parenthood, condition can be tested using the “parent” condition between the code members in the pair, as explained in detail, with reference to FIG. 17. The matching codes (for the same documents) result from the join operation. Thus, the document is di and the respective codes are cj (for WorkofArt) and ck for Artist (V-176). Note that the location of the words WorkofArt and Artist in di can readily be derived from the respective codes cj and ck. There may be, of course, more than one document and/or more than one pair per document which result from the join operation.

Next, another join is applied to the results of the previous join (i.e. document di with Workofart and Artist that maintain the appropriate parent child relationship) and name (designated n3). Note from FIG. 15 (V-132) that Artist is a parent of name. The join conditions are prescribed in V-178, i.e. still the same document is sought: n2.doc=n3.doc, and further that n2 is a parent of n3. In the case of successful result, in addition to the specified cj and ck codes (for Workofart and Artist) additional code c3 is added, identifying the location of name in the same document (di), obviously whilst maintaining the query constraints, i.e. that artist is a parent of name. In the same manner, a series of joins are performed for the rest of the words, i.e. Van Gogh, Gallery, Orsay and title, designated collectively as V-179. In the case of success, each of the specified words has a resulting at least one code identifying its location in the document (by this example c4-c7). The net effect is, therefore, that location of the sought words (appearing in the concrete query tree) in the document (or documents) is determined (by their respective codes) and the structural relationship is maintained between them, in the manner prescribed by the query tree.

Note that the specified translation (e.g. the execution of the A2C algorithm) and evaluation pattern matching process (e.g. the series of joins, discussed with reference to FIGS. 17 to 19), are all performed, by this embodiment, in the same index machine and considering the preferred embodiment where the sub-view and the index are all accommodated in the main memory, the processing is performed in an efficient manner.

What remains to be done (step V-95 in FIG. 12) is simply to access to the corresponding repository machine (which, as may be recalled, are also arranged by clusters, and in specific embodiment there is a one-to-one correspondence between an index machine and a repository machine) and to extract the sought data. Thus, when accessing the appropriate repository machine the document identifier, (e.g. di in the example above) serves also as the location identifier of the sought document within the repository machine, facilitating thus immediate access to the appropriate document. The code associated with the requested information (i.e. the code of title, in the example of FIG. 16) serves for readily locating the title data within this document. Note that not all queries require an access to the repository machines and that, sometimes, step V-95 can be skipped. This happens when the only sought information from a specific cluster is the identifiers of the documents that match a given pattern tree rather than some of (or all) the data contained in these documents. This will be illustrated in the description below.

Those versed in the art will, thus, readily appreciate that the pertinent processing in the slow repository machines (which normally store the XML documents in slow external memory) is very limited, thereby does not pose undue overhead on the total query processing duration. The resulting data in the documents are then fed (step V-96 in FIG. 12) to the interface machine which receives the resulting document data from all relevant repository machines (e.g. by this example, in addition to data received from the art repository machine(s), also the data received from the tourism repository machine(s)), and applies the query plan top union operation on the query results (indicated by V-113 in the example of FIG. 14) and delivers them to the user, in a known per se manner.

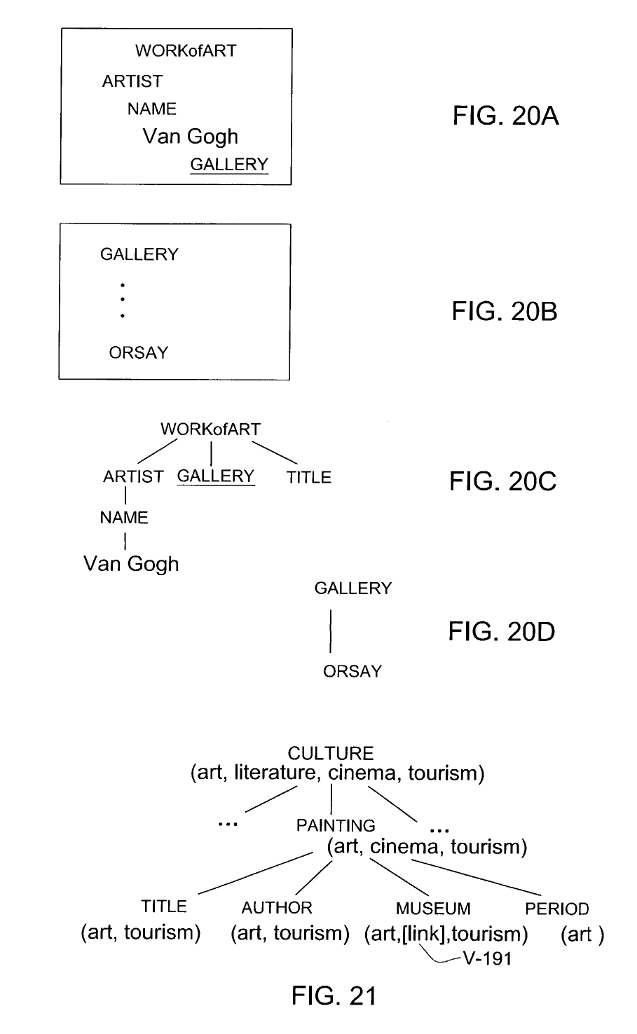

So far, the description referred to documents extracted in reply to a query only if each one of the documents contain all the items sought by a user. However, there are typical scenarios where a reply to a query resides in two or more linked documents. For instance, consider the concrete query tree of FIG. 15 (V-132) and assume, that a document concerning a painting by “Van Gogh” contains a link to another document containing information about the “Orsay” gallery where this painting is exhibited. Put differently, the information about Orsay is not in the same document that includes the information about Van Gogh, but can be found by following a link, (see FIGS. 20A-B, illustrating screen layouts that correspond to the specified two XML documents). Naturally, it is desired that the two documents (represented in FIGS. 20A and 20B) should also be extracted as a result of the query.

Intuitively, one can notice that that each query tree is partitioned into sub queries (sub-trees), each of which should be met by a different document, and then the results should be combined somehow through a combination operation, e.g. by some join operation(s) as will be explained in greater below. For the latter example, the respective sub queries (sub-trees) are depicted in FIGS. 20C and 20D (corresponding to documents 20A and 20B).

The combination can be realized in various manners. However, for simplicity, as before, the description refers to the specified interface machines, index machines and repository machines architecture, as described with reference to FIG. 10. The invention is, of course, not bound by these specific embodiments.

Focusing, at first, on the interface machine, the fact that a link has been encountered within some document is recorded in the annotated abstract tree (whose construction was described, with reference to FIG. 11). The recording of the link can be easily realized during the preparatory step of annotated abstract DTD, i.e. when assigning clusters to concepts. Thus, when a document (that falls, say, in the art cluster) includes a link, this, obviously, is reflected in the corresponding path in the concrete DTD, say WorkofArt/Gallery (link). And, accordingly, the link data is designated in the corresponding abstract path culture/painting/museum in the annotated abstract tree (V-191 in FIG. 21). Except for the link data, the annotated abstract tree of FIG. 21 is identical to that of FIG. 11, described in detail above.

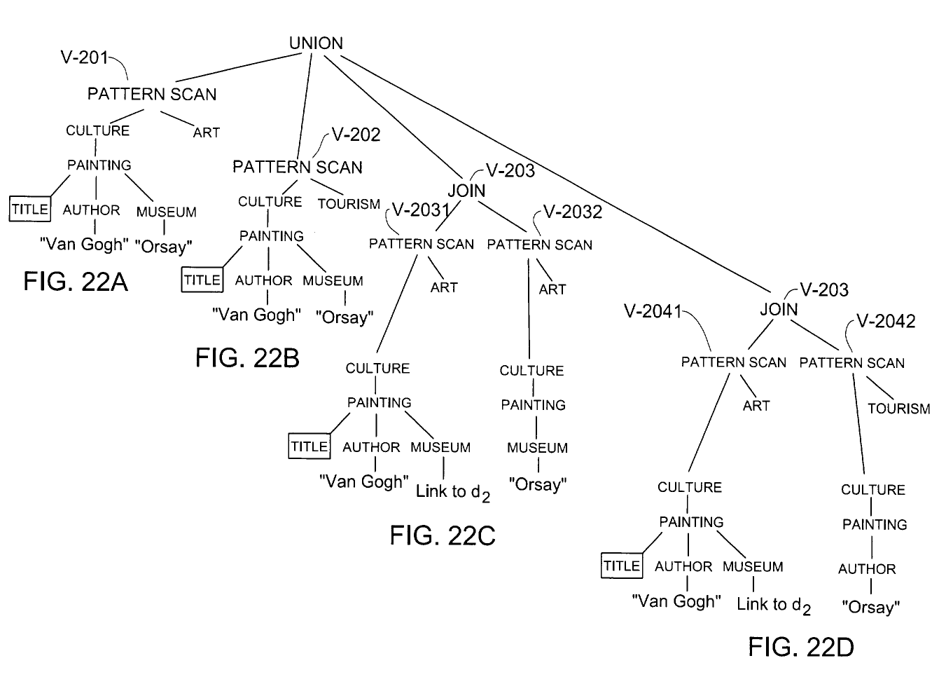

Reverting now to the FIG. 11, the abstract query V-110 was decomposed using the annotated abstract tree into two sub-queries that were communicated to the appropriated index machine (for art and tourism) enabling the respective index machine to translate the abstract pattern trees (V-131 in FIG. 12) into concrete ones (V-132). Now, taking into account the new link information (V- 191), the abstract query V-110 is decomposed (on the interface machine) into a union of four sub-queries (illustrated in FIGS. 22A-D). The two first sub-queries are identical to those of FIG. 11 (V-201=V-111 and V-202=V-112). The last two (V- 203 and V-204) are added to take into account the link information. Each consists of a join between two PatternScan operations. In V-203, the two PatternScans apply to the same art cluster (which has mappings for all paths within the pattern trees and a link below museum), whereas in V-204, one applies to art and the other to tourism (which has mappings for all paths within the pattern tree of V-2042 but lacks a link to fit that of V-2041).

Both sub-queries V-203 and V-204 are evaluated in a similar way. This process will now be explained with reference to sub-query V-203. The original query pattern tree has been split into two sub-trees, one for the first document (i.e. everything except for “Orsay” that is linked to Museum), the second for the second (linked) document (i.e., including Museum and “Orsay”). For convenience of implementation, the full abstract path including the prefix culture/painting is also provided. Each of the corresponding PatternScans will be shipped to the art index machine for further processing as described before. When the resulting documents will be shipped back from the repository machine (after step V-95), the join operation will be evaluated to check that, indeed, the documents returned by sub-query V-2031 contains, within their museum element, a reference to the documents returned by sub-query V-2032. Note that, since sub-query V-203 uses only the identifiers of the documents returned by sub-query V- 2032, there is no need for this sub-query to go through step V-95 (see FIG. 9).

There may be many documents which meet sub-query V-2031 but only few, if any, including a link to some documents returned by sub-query V-2032. The need to extract all the documents that met sub-query V-2031 from the slow repository machine (even if only few of them, if any, include some link to a documents of sub-query V-2032), constitutes a disadvantage which adversely affects the performance.

By a non-limiting modified embodiment, the latter limitation is coped with. Thus, by this modified embodiment, sub-query V-2031 (resp. V-2041) and sub-query V-2032 (resp. V-2042) are both shipped to their respective index machines. In the latter sub-query V-2032 (resp. V-2042) is processed (steps V- 93-94) giving rise to the identification of museum documents (p2.document in FIG. 19). This, as may be recalled, is performed in the fast main memory. At the same time, the pattern tree of sub-query V-2031 (resp. V-2041) is translated from abstract to concrete (step V-93). Then, instead of shipping its results back to the interface machine, sub-query V-2032 (resp. V-2042) sends them to where sub-query V-2031 (resp. V-2041) is being processed (which may be the same index machine, as is the case for V-203, or not as is the case for V-204). The identified documents (p2.document in FIG. 19) are then injected one after the other into the concrete pattern trees of sub-query V-2032 (resp. V-2042) and thereafter step V-94 is implemented. Note that the evaluated concrete pattern trees are the same than with the previous evaluation except for the fact that the identifier of p2.document is now a child of museum. The evaluation using the index is then performed in an identical manner as described with reference to FIG. 16B, except for additional evaluation step, i.e. join V-211 in FIG. 20 which prescribes a parent relationship between museum and the identifier (i.e., the url) of doc2 (which is a document returned by sub-query V-2032, resp. V-2042). Note that this identifier is simply a word as is “Van Gogh” or “Orsay”. The other joins (designated generally as V-212 in FIG. 20) are as described with reference to FIGS. 16A-B.

The result would be documents that meet all the provisions of sub-query V-2031 (resp. V-2041) and further the condition that museum is linked to the documents returned by sub-query V-2032 (resp. V-2042).

Note that by this modified embodiment, the processing of the join operation that is the root of sub-query V-203 (resp. V-204) is performed on the index machine and that access to the repository machine is made only to extract the title elements that constitute the final result. The slow access is, thus, limited to only what is absolutely necessary.

The specified example referred to only one link museum for one cluster art and two clusters (art and tourism) for the linked documents. It required two joins sub-queries (V-203 and V-204). Had there been, for example, an additional link for tourism two more joins would have been necessary:(i) between tourism (link) and art (linked); (ii) between tourism (link) and tourism (linked). In case of more links, the specified procedure is performed mutatis mutandis.

It is accordingly appreciated that the more links there are, the more joins are required. Joins lead to a potential exponential growth of the query algebraic plan and, accordingly, to undue long processing time for queries that are much too complex to be answered. In practice, the processing time remain relatively small because (i) abstract DTDs concern few clusters, (ii) queries are naturally small, and (iii) not all nodes have links. Still, worst cases can always occur.

A possible solution to reduce processing time would be, for example, to consider joins only as a backup when no or too few answers are found. Thus, by a non-limiting example, if the query is met by documents with no link, the specified join operations are not applied. Only if none or few answers are found, the specified union join operations are applied, trying to find the more answer in by combining two or more documents.

Note that the invention is by no means bound by the procedure described with reference to FIGS. 21 to 23, for applying union join of sub-queries in the case that the items of a query reside in more than one document.

There are cases where documents that do not meet the provisions of the query (i.e. they have slightly different structure than that prescribed by the query) would, nevertheless, be of interest to the user. To this end, a query relaxation procedure may be applied.

The description below refers to few non-limiting embodiments for query relaxation. (i) Avoiding to apply the PreserveAscDesc constraint on the A2C algorithm, described above. Under this relaxation procedure, the path painter/painting would be an appropriate match for the abstract path culture/painting/author. Note that by this embodiment the processing complexity of A2C is increased. More precisely, when constructing an upward path, all combinations of mappings having the same concrete root should be considered. (ii) the conditions on joining nodes is relaxed. For instance, consider the query of FIG. 15, the node painting is disregarded, meaning that the parenthood relationships, between culture and painting, painting and title, painting and author, and painting and museum are not checked in the join evaluation of FIG. 19. This would possibly bring about more resulting documents. The rational is that the user may be interested in documents with culture, title, author, museum, Van Gogh, Orsay in the structure prescribed by tree V-131 without necessarily having the word painting in the resulting document, or, alternatively, with the word painting appearing, however, not as prescribed in the structure tree V-131 (e.g. the word painting appears, however, not as a child of culture). (iii) Conventional, known per se keyword search. For instance in the example of FIG. 15(V-132), only the key words Van Gogh and Orsay are searched. To this end, known, per se, full index techniques may be utilized.

Having described an exemplary architecture and operation of store module 13 and associated Information Delivery module 14 (of FIG. 1), there follows a discussion of additional operations performed in the Information Delivery modulel4 (in association with module 13) which by this embodiment concern Built in support in the query language for ranking the results according to relevance and for relaxation, where relevance and relaxation are based on pre-defined criteria as well as user criteria.

Thus, optimization of queries and in particular pipelining of execution to provide good performance and support “First Answers First”. I.e. the ability to get sequences of N responses with the need to wait till the system finds ALL the responses to the query.

Queries sort documents in the order that they were added into the repository. Normally, documents are loaded into the repository by date. Therefore, the most recent results will appear first, and less recent results will appear afterwards.

In accordance with this embodiment, The query language contains e.g. a BESTOF keyword that is used to sort query responses by relevancy. The BESTOF keyword sorts the results by relevance. When one defines the BESTOF expression, one sets the criteria for the relevance.

A BESTOF query searches for a single search term in multiple levels of increasingly general locations. It then assigns relevancy levels to the responses which correspond to the location in which the response was found.

Given a particular search term, it may first search for that term in a particular element, then the parent element, and finally in the parent document. The results found in the first element searched are most relevant, and the results found in the parent document are least relevant.

The BESTOF keyword provides a way to evaluate a query in phases. These phases are called relaxation phases.

For a better understanding of the foregoing, there follows a discussion disclosed also in U.S. patent application Ser. No. 10/313,823 entitles “Evaluating Relevance of Results in a Semi-Structured Database System” filed Dec. 6, 2002, whose contents in its entirety is incorporated herein by reference.

Before turning to describe various non-limiting embodiments of the invention in connection with query ranking, it should be noted, generally, that in traditional query processing, the whole repository of documents is processed to yield a set of results that meet the query. Each result is a document or portion thereof or combination of portions of documents. The set of results is then evaluated (e.g. ranked according to pre-defined criteria) and displayed to the user. This approach is costly when querying large repositories or applying complicated queries, since the response time to the user may be quite long before the first result is displayed. In contrast, in pipeline processing, the results are processed in steps, such that in each step 1 to n results are processed and the first results are returned fast, typically consuming reduced memory resources. Before moving forward it should be noted that when reference is made below to the term “the invention” in the context of description of query ranking, it should be construed as referring to embodiment(s) of the invention that employ query ranking.

As will be explained in greater detail below, the invention provides, in certain embodiments, an implementation of the specified indication of relevance ranking in a traditional manner and by other embodiments in a pipelined manner.

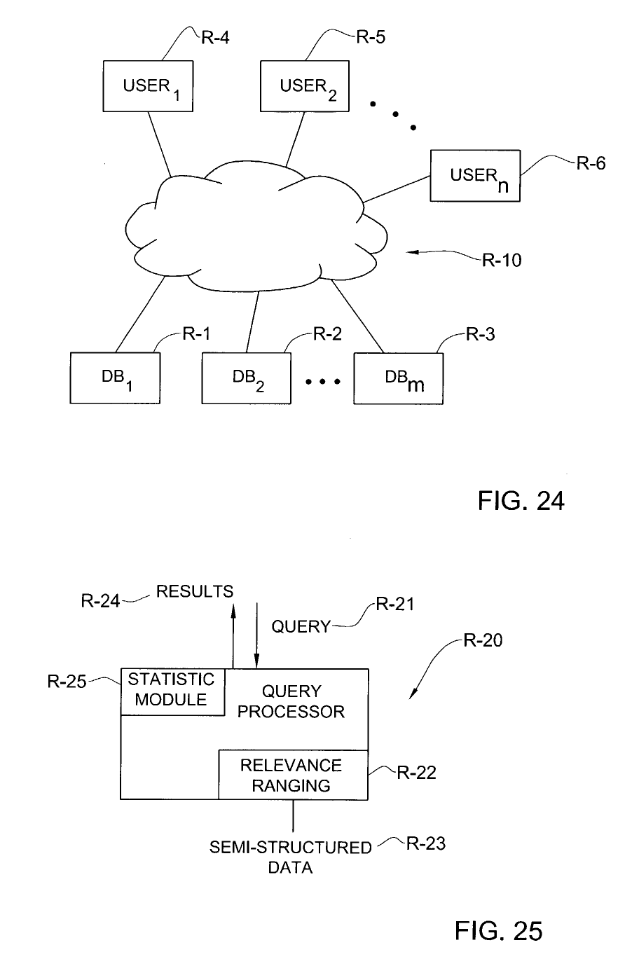

Bearing this in mind, attention is drawn, at first, to FIG. 24, showing a generalized system architecture (R-10) in accordance with an embodiment of the invention. Thus, a plurality of servers of which only three (designated R-1, R-2 and R-3) are shown, store semi-structured data which has been loaded and subjected to on-going enrichment, in the manner described above. Note that each of the servers may have access to other servers and/or other repositories of semi-structured data. Accordingly, the invention is not bound by any specific structure of the server and/or by the access scheme (e.g. index scheme) that it utilizes in order to access semi-structured data stored in the server or elsewhere. By this embodiment, the specified server representation is simplification of the detailed architecture of the store (e.g . 13 of FIG. 1), discussed above.

System R-10 further includes a plurality of user terminals of which only three are shown, designated (R-4, R-5, and R-6), communicating with the servers through communication medium, e.g., the Internet.

By one embodiment, there is provided a user application executed, say through a standard browser for defining queries and indicating therein relevance ranking. Thus, for example, a user in node R-4 (being a form of the information delivery module R-14 of FIG. 1) places a query with designation of relevance ranking, the query is processed by query processing module (discussed in greater detail below) using data stored in one or more of the server databases R-4 to R-6. The resulting data is then communicated for display at the user node. The response time for displaying the data depends, inter alia, on whether a traditional or pipeline approach is used. Note that when reference is made to query in context of query ranking discussed below, it embraces also query tree discussed above.

The invention is, of course, not bound by any specific user node, e.g., P.C., PDA, etc. and not by any specific interface or application tools, such as browser.

Attention is now drawn to FIG. 25, illustrating schematically, a generalized query processor (R-20) employing a relevance ranking module in accordance with an embodiment the invention. Query module (R-20) is adapted to evaluated queries (e.g. (R-21)) that are fed as input to the module and which meets a predefined syntax, say, the Xquery query language. Continuing with this embodiment, queries can further include relevance ranking primitives which will be evaluated in relevance ranking sub-module (R-22), against semi-structured data, designated generally as (R-23), giving rise to results (R-24). Note that whereas query processor R-20 was depicted as a distinct module, it may be realized in many different implementations. For example, the whole query processing evaluation may be realized in one DB server or executed in two or more servers in a distributed fashion. By way of another non-limiting example, part of the query evaluation process may take place in a user node.

In accordance with one embodiment of the invention, there is provided a new use of existing semi-structured query language (e.g. Xquery query language) that is formulated in a manner for performing relevance ranking. This is based on the underlying assumption that the documents structure (to which the query applies) is known and that certain parts thereof can be queried according to the desired relevance. This is a non-limiting example of usage of the structural positioning of the words in order to specify the desired relevance ranking. Note that words refer to leaves.

Accordingly, by this embodiment, the more important parts (having higher rank insofar as the user interest is concerned) are queried first and the less relevant parts (having lower rank) are queried afterwards etc. Thus, when knowing the documents structure, it is, for instance, possible to achieve head preference by requiring first the documents that contain the given words in the first part of the document structure (having, in this context, higher relevance ranking) then in the second part (having, in this context, lower relevance ranking), and so on.

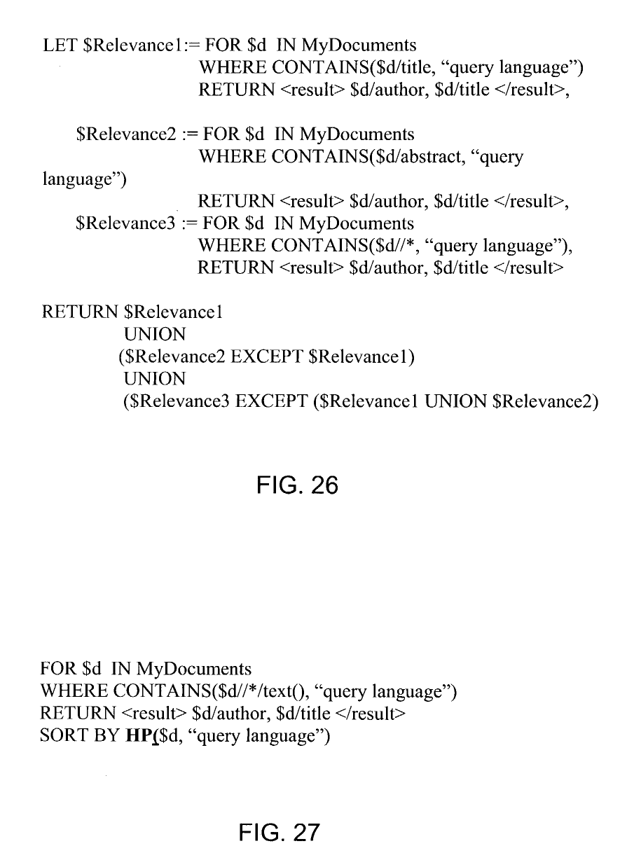

For a better understanding of the foregoing, consider an exemplary set of documents with title, abstract and body. The X-Query example (being a non-limiting example of semi-structured query languages) illustrated in FIG. 26 returns, ordered by “head preference”, the titles and authors of the documents containing “query language”. This embodiment of the invention is not bound by the specific use of Xquery, and accordingly, other query languages for semi-structured data can be used, depending upon the particular application.

As shown, in the first phase a first clause, designated Relevance1, is evaluated which calls for retrieval of documents having at their title the combination “query language” (hereinafter first list). Then, in the second phase, the second clause, designated Relevance2, is evaluated which calls for the retrieval of documents having at their abstract the combination “query language” (hereinafter second list). However, since some of the documents in the second list were already retrieved in the first list (i.e. they have “query language” both in the title and in the abstract), it is required to exclude those that were already retrieved in the first phase and this is implemented using the EXCEPT primitive (i.e. $Relevance2 except $Relevance1). Now the two sets need to be unioned. Consider, for example, a first document d1 where “query language” appears in the title and the abstract, a second document d2 where “query language” appears only in the title and a third document d3 where “query language” appears only in the abstract. Then, Relevanve1 would give rise to d1 and d2; Relevanve2 would give rise to d1 and d3; and after applying EXCEPT d3 remains and eventually the UNION give rise to d1, d2 and d3.

Note that already at this stage it is clear that the results can be provided at least partially in a pipelined fashion since at first the results at the higher rank (where the combination “query language” appeared in the title, e.g. d1 and d2 in the latter example) are retrieved and thereafter in the second phase the documents having lower rank (where the combination “query language” appeared in the abstract, e.g. d3 in the latter example) are retrieved.

Reverting now to the above example, and turning to the lowest rank, the third clause (implemented by the statement $Relevance3 EXCEPT ($Relevance1 UNION $Relevance2) will give rise to documents having at their body the combination “query language”.

Note that the evaluation is performed in phases according to the rank, each phase eventually decomposed into steps, whereby in this embodiment, the higher rank (title) is initially evaluated. For each rank (say the highest one-title) the evaluation is performed in one or more steps where in each step one or more results are obtained. The step size, may be determined, depending upon the particular application. Note also that whereas by this example, full documents were retrieved as a result, by another non-limiting embodiment, only relevant portions thereof are retrieved, all depending upon the particular application.

The pipeline evaluation afforded by the use of semi-structured query language in accordance with this embodiment of the invention is an important feature when large collections are concerned. Indeed, keyword searches (such as in IRS, see discussion above) are not always selective and may lead to returning a large portion of the database (even the full database). By returning/evaluating first results fast, a system (i) heavily reduces memory consumption, (ii) gives more satisfaction to its users who do not have to wait to get a first subset of answers, and (iii) potentially reduces processing time since users can stop the evaluation after the n first subsets of answers. Another advantage in accordance with this embodiment is that there is no need to modify the existing semi-structured query language, but rather it is used in a different fashion to facilitate relevance ranking in semi-structured databases.

In accordance with another embodiment of the invention, ranking queries by relevance relies on at least one external function, e.g. function(s) defined in a programming language that does not form part of the semi-structured query language itself but which can, nevertheless, be applied within the language. The query language is, thus, formatted to indicate the relevance ranking, using this external function.

For instance, assume that the function named HP( ) has been developed to compute “head preference”. An exemplary use of same query (as in FIG. 26) in accordance with this embodiment is illustrated in FIG. 27. Thus, the identification and titles of the documents having the combination “query language” will be retrieved, after having been sorted in accordance with the results of the HP function which orders first the documents having this combination at their title, then documents having this combination at their abstract, and lastly documents having this combination at their body. Note that in the latter embodiment, the evaluation requires the accumulation of all results before the first one can be returned to the user, thereby offering traditional and not pipeline evaluation.

In accordance with another embodiment of the invention, there is provided a technique for incorporating, in a semi-structured query language, means for indicating relevance ranking. By one embodiment, this is accomplished by the provision of a distinct operator which can be integrated in the semi-structured query language. This affords a simple manner of designation of relevance ranking in semi-structured query languages as well as in a scalable way in order to efficiently evaluate a query on a large database so as to return the most relevant results fast.

Thus, by one embodiment, there is provided an operator designated BESTOF, allowing users to specify relevance in a simple way. Note, generally, that there are many ways to evaluate relevance depending upon, inter alia, the application and/or the user. Note, that even when the same application is concerned two queries within the same application may require different ways to compute relevance.

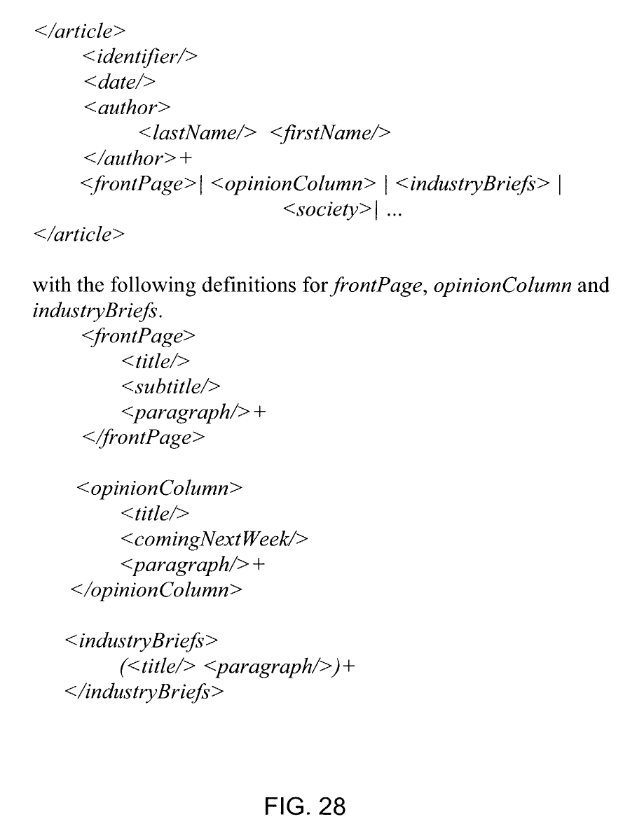

For a better understanding of the foregoing, consider, for instance, an application that manages the archives of a newspaper whose document tree structure is as depicted in FIG. 28. FIG. 28 defines an article with article identifier, date and author(s) details as well as distinct definitions for front page (title, subtitle, and one or more paragraphs), Opinion Column (title, ComingNextWeek and one or more paragraphs), and IndustryBriefs (one or more titles and paragraphs).

Bearing in mind this structure Consider the two following queries:

get the articles talking about “war” and “Afghanistan”

get the articles talking about the “merger” of Companies “X” and “Y”

Obviously, word proximity is important in both queries. Another important criterion for both queries is the head preference, i.e. position of the words within the documents, say, preferably, in the title. Thus, for the first query, finding “war” and “Afghanistan” in the title field of the document is certainly better than finding them in some arbitrary paragraph or, worst, in the comingNextWeek field of opinionColumn. By the same token, for the second query finding “merger” and “X” and “Y” in the title would be better than finding them in some arbitrary paragraph or, worst, in the comingNextWeek field of opinionColumn.

However, for a lower preference there may be different definitions. For example, for the second query a best candidate (for second preference) may be to find “merger” and “X” and “Y” in paragraph below industryBriefs, rather than simply paragraph. This condition is, obviously, of no relevance for the first query since finding “war” and “Afghanistan” in Industry Briefs is of very little or possibly no relevance.

By this embodiment, the BESTOF operator would be able to capture the specified distinctions and others, depending upon the specific application and need. In this context the specified example with reference to the two queries and the document depicted in FIG. 28 is provided for clarity of explanation only and are by no means binding as to the granularity that the BESTOF operator can be used in order to capture the user's preference.

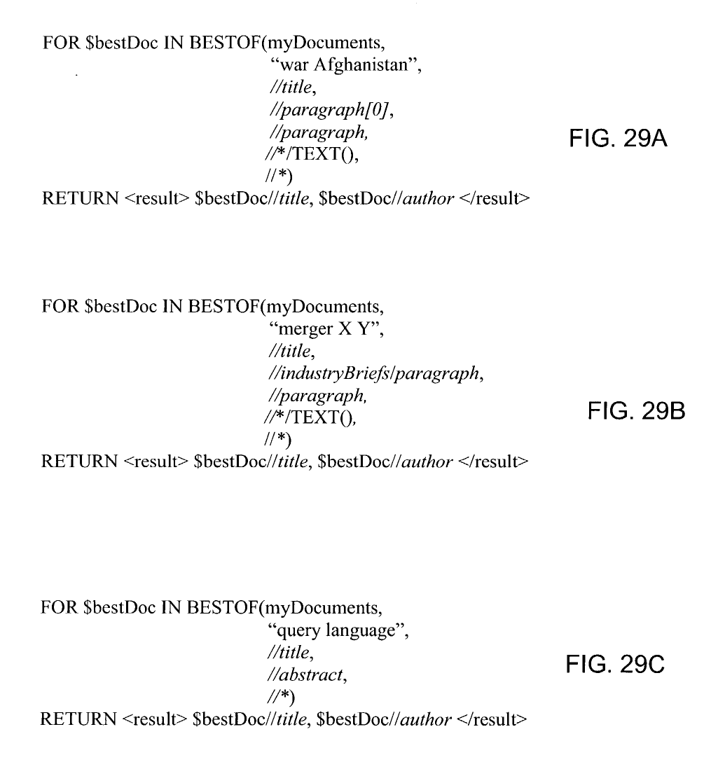

Continuing with this non-limiting example, an appropriate indication of relevant ranking for the two queries using the BESTOF operator would be formulated in an exemplary manner as illustrated in FIG. 29A (for the first query) and 29B (for the second query).

Thus, as shown in FIG. 29A, for the first query the first priority would be title, the second would be in the first paragraph (designated paragraph[0] in FIG. 29A) and the third priority is in any other paragraph of the document. For the query in FIG. 29B, the first priority would be title, the second would be in a paragraph in IndustryBriefs and the third priority is in any paragraph of the document. Using the BESTOF operator for the query described with reference to FIG. 26, would lead to the form depicted in FIG. 29C, where the first priority is to locate “query language” in the title, then in the abstract and finally elsewhere. Note that the structural positioning of the words in the document (by this example the scheme of FIG. 28) is utilized for the relevance ranking.

In accordance with this specific embodiment, the syntax of a BESTOF operation (used in the exemplary queries of FIGS. 29A, 29B and 29C) is the following:

BESTOF (F, SP, P1, P2, P3, . . . )

Where:

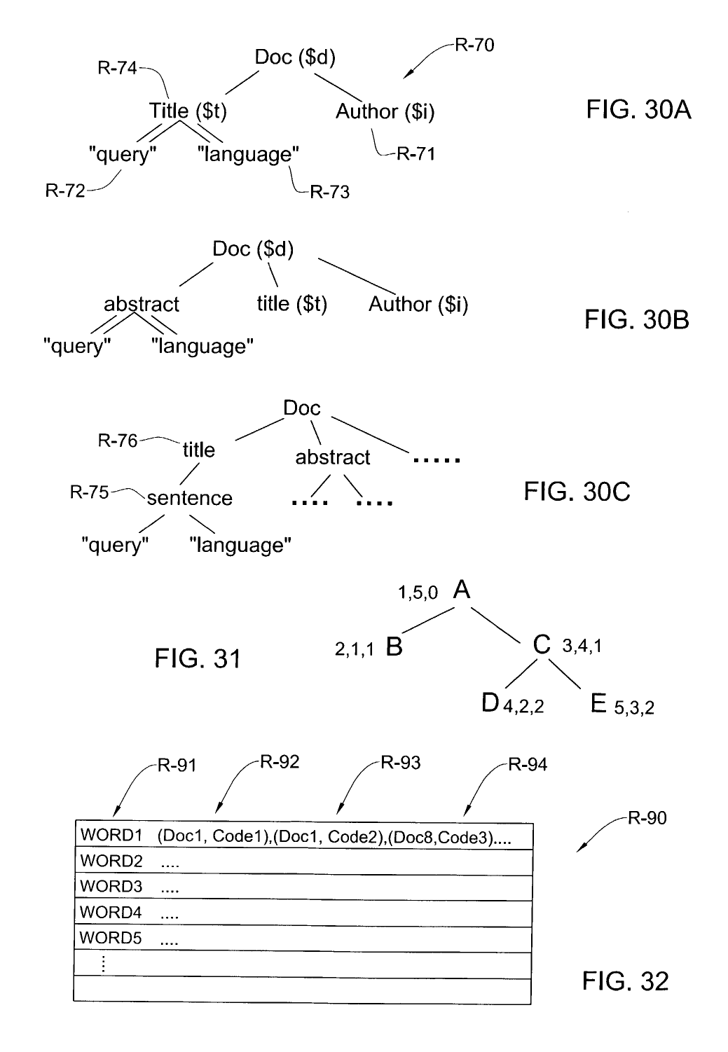

1. F: a forest of XML nodes (i.e., documents; note that a node designates the subtree rooted at this node, for instance, in FIG. 30a, “DOC” is a node and it represents the tree rooted at this node), elements, text, —for instance, myDocuments specified in the non-limiting examples of FIGS. 29A-C).

2. SP: a string predicate. In the examples illustrated with reference to FIGS. 29A to 29C, the predicate was a simple string (e.g. “war” “Afghanistan”) and considered as a conjunction of words. It is, of course, possible to build more complex predicates using standard connectors, such as: and, or, not, phrase. For instance, (& (| “war” “conflict”) “Afghanistan”) matches any string/element containing “Afghanistan” as well as either “war” or “conflict”. One can also mix path expressions and words. For instance, assume that a sub-element named keywords is added to each element in the document. Then, a predicate could be (& (| “war” “conflict”) “keywords//Afghanistan”). It would match any element with a sub-element keywords containing “Afghanistan” and also containing either “war” or “conflict”. The expressive power of SP can be extended to any arbitrary function.

3. P1, P2, . . . , Pn: 1 to many XPath expressions; for instance P1 stands for //title, and P2 stands for //paragraph[0] in the example of FIG. 29A.

The result of the BESTOF operation is a re-ordered sub-part of the forest F defined as follows: BESTOF (F, SP, P1, P2, . . . , Pn)=Fres={N1, N2, N3, . . . , Nm} with:

I. For all nodes N in F, if there exists j in [1,n] such that Pj applied to N satisfies SP then N is part of Fres. In simple words, this condition requires that for each resulting document in the result set, there exists at least one Xpath expression among P1, P2, . . . , Pn that satisfies the string predicate SP.

II. For all i in [1, m] there exists j in [1,n] such that Pj applied to Ni satisfies SP. Let jmin(i) be the smallest such j for a given i. In simple words, this condition requires that the result set consists of only such documents. jmin(i) is an auxiliary operator which will serve for ordering the documents by their rank, as will be explained in greater detail with reference to the following condition (C):

III. For all i in [1, m−1], (jmin(i)<jmin(i+1)) or (jmin(i)=jmin(i+1) and Ni is before Ni+1 in F). This condition deals with the order of the documents, i.e. specify that a first document will be ordered (in the result) before a second document. This condition is satisfied when either of the following conditions (1) or (2) are met:

1) jmin(i)<jmin(i+1), i.e. the higher ordered document has higher rank (where jmin is an auxiliary operator used to this end). For example, when referring to the example of FIG. 29A, a first document having “war” and “Afghanistan” in the title has a smaller jmin(i) value then a document having “war” and “Afghanistan” in the abstract (with higher jmin(i+1) value), and therefore the former will be ordered before the latter. This illustrates in a non limiting manner structural positioning of words. Thus the word in the “title” has a “better” position in the structure compared to word in other (inferior) position in the structure, i.e. the “abstract”. Note that the specification of positioning is by way of path expression, e.g. document//title compared to document//abstract.

2) (jmin(i)=jmin (i+1) and Ni is before Ni+1 in F); this means that the two documents have the same rank (e.g. both having “war” and “Afghanistan” in the title), as indicated by jmin(i)=jmin(i+1) BUT the first document is located before the other in the searched repository, and therefore will also be ordered before in the result.

Note that the invention is not bound by the specific example of BESTOF operator, as well as by the specific syntax and semantics thereof, which is provided herein by way of example only.

Note also that by this example, BESTOF captures the head preference criterion in the relevance computation. Thus, for example, documents having the sought string in the title were ranked before those having the sought string in the abstract. The BESTOF operator can capture other criterion such as proximity (being another example of utilizing structural positioning of words and re-occurrence, as will be explained in greater detail below).

By another embodiment, the BESTOF operation returns the nodes found at the end of the Pi paths rather than the nodes in F. Put simply, instead of returning the documents, the paragraphs in the documents, portions thereof, e.g. a portion of a document satisfying the string predicates is returned.

Having described a non-limiting example an indication of relevance ranking which specifically concerns a provision of an operator which can be integrated in a semi-structured query language, there follows a discussion which pertains to how the actual evaluation of semi-structured data is performed using such an operator. Note that the invention is not bound by the specified operator (as well as by the syntax and/or semantics thereof) and, likewise, not by the specific implementation details of the non-limiting embodiments discussed below.

Before moving to discuss the evaluation details for the semi-structured query language, it is noted, generally, that in information retrieval systems (IRS as discussed above in the background of the invention section) queries are traditionally evaluated as follows:

1. A full-text index is scanned to retrieve, for each query word, a list of information concerning the documents that contain this word. The information usually consists of the document identifier and the offset of the word in the document.

2. The lists are combined in much the same way that words are combined in the query: “And”-ed words lead to intersection, “Or”-ed words to union, etc. To speed up this part of the evaluation, IR systems usually rely on an ordering of the information by document identifier.

3. The relevance of each result of stage 2 above by system-specific functions is computed and the results are sorted accordingly.

The main drawback of this approach is that, for each query, the result of stage 2 has to be stored so that it can be re-ordered according to relevance in stage 3. When the query is not very selective and the database is large, this can be prohibitive, especially if the system has to deal with several queries at the same time. This is why most systems implement a limit. When in stage 2, the number of results reaches this limit, stage 2 simply stops, not considering the other potential answers. Since, at this point, the results are not ordered by relevance, this means that it is possible to miss the most relevant answers. Another drawback of the approach is that the full result has to be computed before the users can see the query first results.

In accordance with the embodiment that utilized the BESTOF operator, the results are also computed in phases. Note that each phase being eventually decomposed into one or more steps. In contrast to the traditional evaluation strategy discussed above, the phases are based on relevance. More precisely, phase 1 computes the most relevant answers, step i the answers that are more relevant than that of phase i+1 but less than that of phase i−1. This is made possible by the ordering of the path expressions in the BESTOF operation (condition C, discussed above in connection with the results of BESTOF). Note that by this embodiment the algorithm is simple enough, i.e., phase i computes the results corresponding to the ith path expression.

An advantage of the evaluation strategy in accordance with this embodiment is that the first results can be returned as soon as they are computed. This is obviously good for the user but also for the system. Indeed, if after having read the n first results the user is satisfied by the answer, the system will not have to compute the remaining answers.

For simplifying the description, the evaluation strategy of the relevance ranking can be defined as follows: Consider BESTOF as a sequence of operations, one per path expression. For instance, the query depicted in FIG. 29C is viewed as a sequence of 3 (pseudo) X-queries:

### EXAMPLE 1

FOR $bestDoc IN myDocuments
WHERE CONTAINS($bestDoc//title, “query language”)
RETURN <result> $bestDoc//title, $bestDoc//author </result>
FOR $bestDoc IN myDocuments
WHERE CONTAINS($bestDoc//abstract, “query language”)
RETURN <result> $bestDoc//title, $bestDoc//author </result>
EXCEPT PREVIOUS RESULTS
FOR $bestDoc IN myDocuments
WHERE CONTAINS($bestDoc//*, “query language”)
RETURN <result> $bestDoc//title, $bestDoc//author </result>
EXCEPT PREVIOUS RESULTS

Assuming that by a specific operational scenario the User asks n results at a time. Each time, the evaluation starts where it has stopped the previous time, consuming the queries in sequence when needed. Each time, the results are stored in the memory and the evaluation ensures that they won't be evaluated and sent (i.e. delivered to the user) again. This is needed because there might be an overlap between two sub-queries, and the system avoids the irritation (insofar as the user is concerned) of delivering the same document again and again in the result list. For example, a document which has the terms “query” and “language” in the title will be delivered as a result when the //title Xpath is evaluated but if it also includes this combination in the abstract, the document will not be delivered again in the result when the //abstract Xpath is evaluated.

By this embodiment, the evaluation stops as soon as the user is satisfied. Note that when there are many results, the user is usually satisfied by the first ones and this strategy leads in certain operational scenarios to a great gain. However, where there are few or no results, this strategy leads to evaluating several queries instead of just one. This imposes only limited computational overhead due to the efficient implementation of the evaluation strategy in certain embodiments that utilize in-memory structure, as will be discussed in greater detail below.

Moreover, in accordance with one embodiment, a known per se statistic module (R-25 in FIG. 25, e.g. used by a known per se database systems, such as Oracle, DB2, etc.) is employed in order to select pipeline evaluation strategy (for many expected results) or traditional evaluation strategy (for few or no expected results). What would be regarded as many results or few results, may be configured, depending upon the particular application.

Note that this evaluation by phases, set forth above, seems similar to the embodiment discussed with reference to FIG. 26, however, as will be better apparent from the detailed discussion below, there is a difference: unlike example of FIG. 26, the system, in accordance with this embodiment, generates the EXCEPT statements, on the fly, and knows what and why they are needed. This knowledge allows optimizing these EXCEPT statements in an appropriate way.

Bearing all this in mind, there follows a detailed discussion of the realization details of the BESTOF operator in accordance with one embodiment of the invention. By this embodiment, the BESTOF operation is realized using a combination of three physical algebraic operators, designated FTISCAN, RELAX and LAUNCHRELAX. The advantage of this approach is that the BESTOF operator can be seamlessly integrated in most database systems since, in many cases, they rely on algebras for the optimization and processing of queries. Note that the invention is by no means bound by this specific realization of the BESTOF operator or the manner in which it is integrated to existing semi-structured query language.

There follows a more detailed discussion of FTISCAN, RELAX and LAUNCHRELAX. Thus,

1. FTISCAN retrieves from an index, in a pipeline mode, the identifiers of the XML nodes satisfying a tree pattern. The tree pattern captures any combination of XPath expressions and string predicates one can apply to a forest of documents. The step evaluation by this embodiment is well fined tuned since a document is retrieved and delivered to the result list upon evaluation thereof, rather than completing the evaluation of the query (say, all the documents that the sought words appear in the title) and only then delivering the documents as a result.

For instance, FIG. 30A below illustrates the pattern tree corresponding to the first phase of Example 1, above.

Considering the first phase of the evaluation of Example 1 (with reference also to FIG. 30A), a correct combination is a tuple with four entries corresponding to title, author, “query” and “language” and such that each entry has the same document identifier (R-71) and shares the appropriate ascendance relationship. I.e., “query” (R-72) and “language” (R-73) are descendant of title (R-74).

Note here another non-limiting example where the structural positioning of the words in the document are utilized for specifying relevance ranking (by this example the higher rank of interest as defined by the specified tuples).

Note also that by this embodiment, the entries are ordered in the index so as to allow pipelining and avoid considering twice the same entry when computing the combinations. In other words, at worst, the evaluation of a pattern over a forest of documents (in the present case, the evaluation of one sub-query in the sequence corresponding to a BESTOF operation) requires a scan over all the entries corresponding to the query words and word element. E.g., title, author, “query” and “language” in the first phase of the Example illustrated in FIG. 29C. This is in fact a worst complexity that is rarely reached since:

The index implements “accelerators” (or secondary indexes) for words/elements with many entries in the index. Once an entry is chosen for one word/element of the query (e.g., “language”), an accelerator can be used on each frequent word/element (e.g., title) to skip part of the scanning and go as near as possible to its next valid entry.

The entries are grouped by documents. Thus, once an entry has been chosen for one word/word element, scanning the other words/word elements entries that do not correspond to the same document is avoided.

FTISCAN also memorizes the minimal information to avoid evaluating and retrieving twice the same result in the context of a BESTOF operation. In Example 1, this minimal information is the document identifier. This information is also used to avoid unnecessary scanning. Thus, a document whose identifier is already stored will not be reviewed again in subsequent phases, for instance, in the second phase of EXAMPLE 1 above, where the combination “query” and “language” is searched in the abstracts of the documents. This characteristic brings about an inherent realization of the EXCEPT operator, since documents whose identifiers are stored (meaning that they were delivered to the user as a result) will automatically be excluded from future consideration.

Reverting to the specific realization of the FTISCAN, its implementation by this embodiment, relies on the existence of an index that associates to each word or element a list of entries of the form: (document identifiers, position within the document). The position is computed in such a way that given two nodes within the same document, their ascendance relationship is known (i.e., one is an ancestor/parent of the other or they are not related). This information is used to join the entries corresponding to all the words/elements of the query so as to get the combinations satisfying the tree pattern.

For a better understanding of the foregoing, attention is drawn to FIG. 31 that illustrates a coding scheme, used in query evaluation procedure, in accordance with an embodiment of the invention.

In order to answer structured queries such as name” is a parent of “Jean”, or “person” is an ancestor of both “name” and “address”, a so called Dietz's numbering scheme is used, (exemplified with reference to FIG. 31) in accordance with one embodiment. More precisely, each word that is encountered in the document is associated with its position in the document relatively to its ancestor and descendant nodes. Note that this is performed as a preparatory stage that precedes the actual query evaluation.

The position is encoded by three numbers that are designated pre-order, post-order and level. Given an XML tree T, the pre and post order numbers of nodes in T are assigned according to a left-deep traversal of T. The level number represents the level tree.

This encoding is illustrated in FIG. 31. Thus, the left number for each node is the pre-order number, i.e. signifying visit order of the nodes in left traversal of the tree, i.e. A, B, C, D, E, and accordingly, these nodes are assigned with pre-order numbers 1, 2, 3, 4, 5, respectively. The middle number represents post-order numbers, signifying the post order visit of the nodes, i.e. B,D,E,C,A and accordingly, these nodes are assigned with post-order numbers 1,2,3,4,5, respectively. The right number in the code is the level number in the tree, i.e. 0 for A, 1 for B and C, and 2 for D and E.

Bearing this in mind, the following conditions hold true:

n is an ancestor of m if and only if pre (n)<pre (m) and post (m)>post (n)

n is an parent of m if and only if n is an ancestor of m and level(n)=level(m)−1

By the index scheme of this embodiment, the preliminary encoding described with reference to FIG. 31, would assign for every word appearing in a document its code, and this applied to all the documents that are to be queried.

For a better understanding, consider, for example, the full index R-90 (FIG. 32) for the words in the repository of documents to be queried, residing in one or more servers (see FIG. 24). Word1, word2 and onwards are all the words appearing in one or more documents. Note that the term ‘word’ encompasses a leaf word (e.g., “query”) or the name of an element (e.g., Title). For each word, say word1, the index data structure includes pairs, each, designating a document and a code. Thus, word1 (R-91) is associated with three pairs, the first (R-92) indicates that Word1 is found in document no 1 (Doc1; note that Doc1 is in fact identifier specifying the location of this document in the repository machine), and that its code is code1 (i.e., the triple number code explained above, with reference to FIG. 31). Similarly, the second pair (R-93) indicates that the same word appears in the same document Doc1, however, in a different location—as indicated by code2, and the third pair (R-94) indicates that the same word appears in document no. 8 and at location identified by code3, and so forth. Note that the invention is not bound by the specific full index scheme, discussed above.

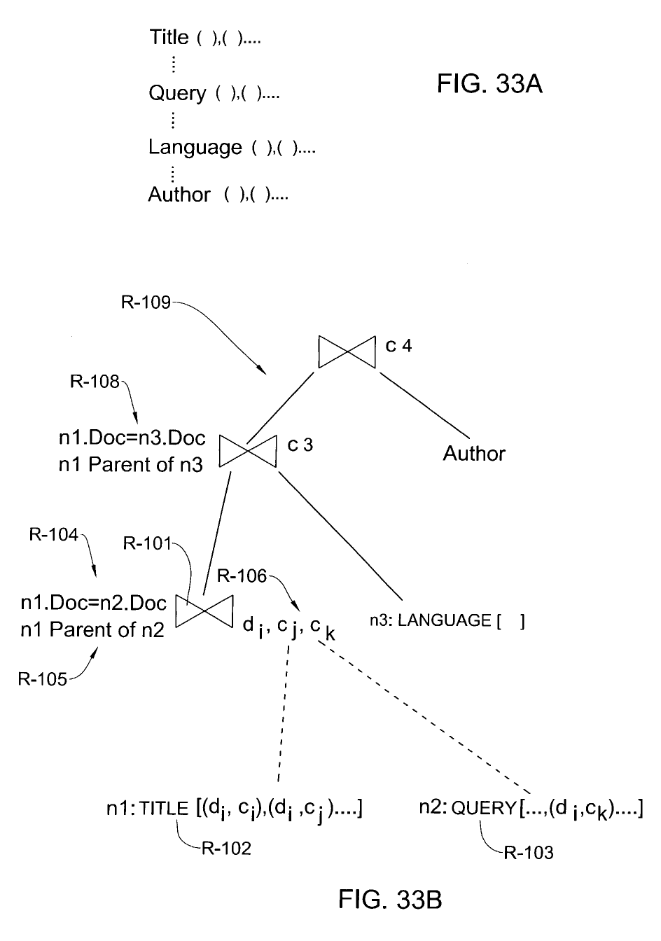

Attention is now drawn to FIGS. 33A-B illustrating a sequence of join operations, used in a query evaluation process, in accordance with an embodiment of the invention. One will recall that there is already available an index (see, e.g. FIG. 32) for all the words of semi-structured documents.

In particular, the index includes all the words of the pattern tree of the present example, i.e. R-70 of FIG. 30A. FIG. 33A illustrates the relevant entries in the index table that concern only the words of the query pattern tree R-70, each associated with pairs of document number (Di) and code (Ci). In FIG. 33A, the associated pairs are shown, for clarity, only in respect of the pattern of FIG. 30A. If there are more pattern query trees (say the one depicted in FIG. 30B, discussed below), the evaluation process applies, likewise, to each one of them. For simplicity, the description below assumes that only one pattern tree R-70 of FIG. 30A that is now subject to evaluation.

The goal of the query evaluation stage is to find document or documents that include all the words and maintain the hierarchy prescribed by the query tree.

One possible realization is by using a series of join operations, shown in FIG. 33B. The invention is by no means bound by this solution. Taking, for example, the first condition, it is required that the words query) and title appear and that the latter is a parent of the former. To this end, a join operation R-101 is applied to the pairs (di, cm) of Title R-102 (designated also as n1) and the pairs (dj, cn) of Query R-103 (designated also as n2). Respective pairs of Title and Query will match in the join operation only if they belong to the same document (i.e. n1.doc=n2.doc R-104) and n1 is a parent of n2 (R-105). The former condition is easy to check, i.e. the respective pairs should have the same di member of the pair. The second, i.e. parenthood, condition can be tested using the “parent” condition between the code members in the pair, as explained in detail, with reference to FIG. 31. The matching codes (for the same documents) result from the join operation. Thus, the document is di and the respective codes are cj (for Title) and ck for Query (R-106). Note that the location of the words Title and Query in di can readily be derived from the respective codes cj and ck. There may be, of course, more than one document and/or more than one pair per document which result from the join operation.

Next, another join is applied to the results of the previous join (i.e. document di with Doc Title and Query that maintain the appropriate parent child relationship) and Language (designated n3). Note from FIG. 30A (R-70) that title is a parent of Language. The join conditions are prescribed in R-108, i.e. still the same document is sought: n1.doc=n3.doc, and further that n1 is a parent of n3. In the case of successful result, in addition to the specified cj and ck codes (for Title and Query) additional code c3 is added, identifying the location of language in the same document (di), obviously whilst maintaining the constraints, i.e. that title is a parent of Language. In the same manner, another join is performed for the author designated collectively as R-109. In the case of success, author has a resulting code or codes identifying its location in the document (by this example c4). The net effect is, therefore, that location of the sought words (appearing in the pattern tree) in the document (or documents) is determined (by their respective codes) and the structural relationship is maintained between them, in the manner prescribed by the query tree.

Note that if the index is arranged in an appropriate manner (e.g. sorted by document identifiers and then by prefix, i.e. the di,ci discussed above) then the join can be evaluated efficiently and in pipeline mode, using a merge algorithm.

Having described the FTISCAN operator and in manner of operation, there follows a discussion that pertains to the RELAX operator. Thus,

2. RELAX is used on top of an FTISCAN operation and implements the change of phases corresponding to a BESTOF operation (i.e. moving from higher rank to a lower one). It modifies the tree pattern of the FTISCAN going from on BESTOF path expression to the next. E.g., when going from phase 1 to 2 in Example 1, the tree of FIG. 30A is changed to the tree of FIG. 30B, expressing also the constraints in respect of abstract, i.e. abstract is a parent of “query” and “language” (meaning that “query” and “language” need to be found in the abstract). Note that title remains because it is required by the RETURN clause, i.e. the user is interested in receiving as a result the document author and the title thereof.

3. LAUNCH RELAX controls the activation of the RELAX operator, i.e., the timing of the phase changes. Note that the designation of the ranking by means of the pattern tree, utilize the structural positioning of the words in the tree.

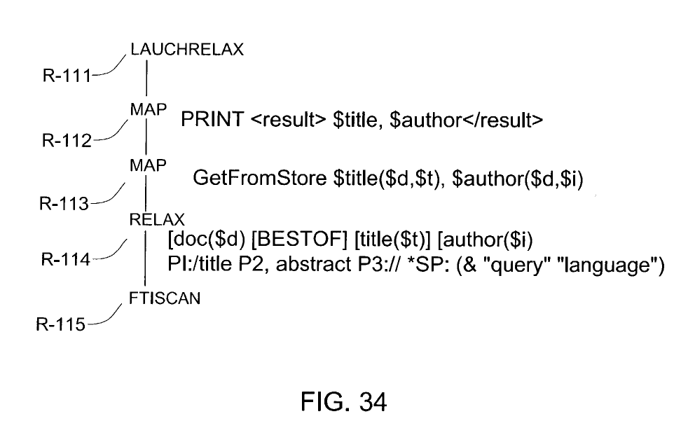

Having described the distinct operators, their operation will now be exemplified with reference to FIG. 34 that illustrates a full algebraic plan that corresponds to Example 1, above. The invention is not bound by this particular implementation.

By this non-limiting example, each operator implements a three standard iterative functions: open (to initialize the operation and its descendant(s)), next (to get the next result) and close (to free its allocated data structure and, through recursive calls, that of its descendants). A fourth one is added, stop, that corresponds to a light close (memory is not freed). The next function returns true if it finds a new result, false otherwise.

The full initialization of the plan is obtained by calling open on its root (i.e., LAUNCHRELAX R-111). Then, next is performed as many times as required by the user. For instance, if the user asks to see results n by n, n nexts will be performed. If she is not satisfied by the first n results, another n results will be calculated and so on. The evaluation stops and a close is performed on the root if either the user is satisfied with the collected answers or there are no more results available (i.e., the next on the root operator returned false). A more detailed discussion follows:

Briefly speaking, on opening, LAUCHRELAX (R-111) records the fact that it is in its first phase of evaluation and pass this information to RELAX. On opening, RELAX (R-114) uses this information to construct the corresponding tree pattern. This pattern is passed down to the FTISCAN (R-115). The first next on LAUCHRELAX launches recursive next calls that lead to the construction of the first result bottom up: FTISCAN returns identifiers for Variables $doc, $t and $a that satisfies the tree pattern and memorizes the DOCUMENT identifier of the documents that have been returned, RELAX does nothing, the lowest MAP (R-113) operation extracts the values corresponding to $t and $a from the store, and the next MAP (R-112) constructs the result. The end of the first phase occurs when FTISCAN returns false. Upon receiving false, LAUNCHRELAX stops its descendants and re-opens them after having incremented its phase counter. This results in RELAX constructing the next pattern (i.e. changing from the pattern tree of FIGS. 30A to 30B). The end of the process occurs either when there is an outside call to close or when, upon opening, RELAX returns false because there are no more paths available.

The inter-relationship between the FTISCAN, RELAX and LAUCHRELAX and the open, next, close and stop commands will be better understood from the following simplified operational scenario.

Assume that there are only two documents in myDocuments that contains “query language”. These documents are: Document d1 with title t1 and author a1, and Document d2 with title t2 and author a2.

In d1, “query language” occurs in the title, in d2 it occurs in the abstract (and not in the title).

Assuming now that the user asks for 5 results. This means that, on the root of the algebraic tree (i.e., LauchRelax R-111), Open is called, then 5 Next (unless the evaluation terminates before), and finally a Close.

1) Open: upon receiving the Open message, LauchRelax (R-111) records the fact that it is the first evaluation phase. Then, it calls Open on its child (Map R-112) that calls Open on its child (2d Map R-113) that calls Open on Relax (R-114). Upon receiving the Open message, Relax constructs the pattern tree corresponding to the current phase (recorded by LauchRelax R-111) and calls Open on FTIScan (R-115) that does nothing.

2) Next(s)

2.1. First Next:

LauchRelax (R-111) calls Next on its child (Map R-112) that calls it on its Child (2d Map R-113) that calls it on Relax (R-114) that calls it on FTIScan (R-115). This sequence of referred to herein as top-down calls. FTIScan finds that [d1, t1, a1] satisfies the pattern tree and returns true along with the result. Going up, Relax (R-114) returns true, the 2d Map (R-113) extracts the values corresponding to t1 and a1 from the store and returns true, the 1st Map (R-112) prints the values and returns true, LauchRelax returns true.

2.2. Second Next

Again, top-down calls are executed, but this time, FTIScan (R-115) cannot find a new result for the given patternTree. Thus it returns false, so does Relax (R-114), and the two Maps (R-113 and R-112). Upon receiving the false value, LauchRelax (R-111) stops all its descendant operations. Then, it records the fact that it enters the evaluation second phase and re-opens the operators as in 1). However, this time, Relax (R-114) builds the PatternTree corresponding to the second phase. Once the opening is done, LauchRelax (R-111) performs a sequence of top-down calls to Next. This time, FTIS (R-115) can return true and [d2, t2, a2]. Going up, Relax (R-114) returns true, the 2d Map (R-113) extracts the values corresponding to t2 and a2 from the store and returns true, the 1st Map (R-112) prints the values and returns true, LauchRelax (R-111) returns true.

2.3. Third Next

This step starts as the previous one, i.e., FTIScan (R-111) first returns false and LauchRelax re-initializes the process for the next evaluation phase. However, the next following the re-initialization also returns false (because there are no more results). Thus, LaunchRelax (R-111) re-closes, records yet another evaluation phase and re-opens. This time, the opening fails because Relax (R- 114) has built all the pattern trees it can build. So it returns false upon opening. In that case, LauchRelax (R-111) stops trying and returns false. The evaluation is thus over.

3) Close

LauchRelax (R-111) calls close recursively on its descendants. Each cleans its data structures.

Considering that FTISCAN, RELAX and LAUCHRELAX have standard APIs and further bearing in mind that open, close, stop and next can also be realized in a known per se manner, the BESTOF operator can be integrated in any query processor, preferably although not necessarily, relying on a standard algebra. In the latter example, standard MAP operations but, obviously, any other operations (e.g., SELECT, JOIN) can be used.

The present embodiment has been described in great detail focusing in pipeline calculation that captures, “head preference” pipeline criterion (e.g. extract documents with the sought words in the title and then in the abstract, etc. It can also capture other criteria, such as proximity. The granularity of the proximity criterion is dictated by the structure of the the pattern. Thus, reverting to the specific example of FIG. 7A, it would be possible to capture word combination that reside in the title, but not at, say sub-title parts.

Consider now the exemplary tree pattern of FIG. 30C, where, as shown, sentence (R-75) is a child node of title (R-76). By this specific example it would be possible to capture the combination of “query” and “language” when appearing within the same sentence in the title. This brings about a finer granularity (for the proximity feature) as compared to, say the pattern tree of FIG. 30A, in the case that the title contains more than one sentence. Obviously, the discussion of the head preference and proximity criterion is not bound to the basic predicate that concerns combination of key words. This example, illustrates, yet another non limiting use of the structural positioning of words for use in relevance ranking.

Other features can be captured, e.g. re-occurrence, where the more instances of the sought word(s) (or phrase etc), the higher the rank conferred thereto. For example, to take into account co-occurrence, a parameter having two values (T for True and F for False) is added to the BESTOF in order to signify the weight that should be given to co-occurrence. When the parameter is operative it is set to T, otherwise, when it is inactive it is set to F.

For instance, for $bestDoc in BestOf (myDocuments, “query language”, T, //title, //abstract, //*) Then, given two documents containing “query language” in their title, the one with the most occurrences of the words is preferred over the other. Note that by this non-limiting example, head preference prevails over re-occurrence. Thus, for an active re-occurrence parameter (i.e. set to T) in the case that there is a document A with only one instance of the word in the title and a document B with many re-occurrences of the word in the abstract, A has a higher rank. The mutual relationship between the head preference and re-occurrence may be altered, using say a parameter with higher resolution values. Consider, for example, a situation where the re-occurrence parameter can receive any value in the 0-1 interval. Thus, for example, by giving a stronger weight (e.g., 0.9), a document with many occurrences of the words in the abstract may be preferred over one with one simple occurrence in the title. Those versed in the art will readily appreciate that the latter examples are by no means limiting and the re-occurrence parameter may be integrated to the relevance ranking algorithm in any desired manner, depending upon the particular application.

Note that, re-occurrence as well as any criterion requiring the aggregation of all results to be evaluated has a cost: the loss of the pipeline evaluation strategy that constitute the second part of the invention. In other words, the results should be collected and evaluated (e.g. to calculate how many time the sought word [or more complex predicate] appears), before results are delivered to the user.

The present embodiment illustrated in a non limiting manner how to provide inter alia (i) a mechanism to express how relevance should be computed in the semi-structured context and (ii) a scalable way to efficiently evaluate a query on a large database so as to return the most relevant results fast.

Having described in detail how to construct a Store (13 in FIG. 1) and Information Delivery Module (14 in FIG. 1) in accordance with an embodiment of the invention, as well as how to obtain query ranking in accordance with an embodiment of the invention, there follows a description of a further non limiting feature that may be employed in the store, in accordance with an embodiment of the CWH invention.

Thus, the store may be further configured to:

Support monitoring of the content to enable query subscription execution. By one embodiment, the Store may monitor a document collection for changes. Based on user preference, it notifies end users and/or applications when a document that might interest them is added to the collection or updated. The notification can be sent by email, or it can be sent as a message to an underlying application. This message can be used by the application to trigger a given operation, such as the appearance of a pop-up box, or to launch a periodical operation.

Note that the invention is not bound by the specified operations of the store and associated information delivery modules, and one or more other operations may be used instead or in addition to the specified list.

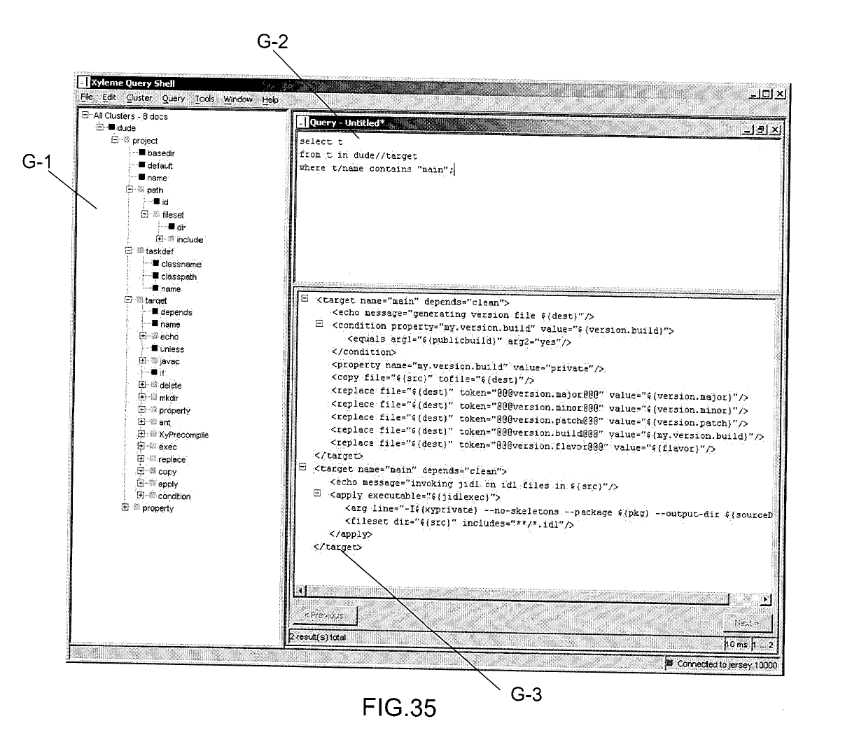

Attention is now drawn to FIG. 35 illustrating a non limiting example of using the BQA module (26 of FIG. 1). As shown, the screen is divided into three parts, no. G-1 illustrating a concrete DTD that represents 8 documents, the right upper part G-2 illustrating a query constructed using the specified DTD and the right lower part G-3 illustrating query results. One possible approach of browsing in order to view any of the desired 8 documents, is by clicking any of the nodes of the DTD chart and in response to receive a list of documents for view. Another non-limiting example of browsing the desired document is by clicking the document ID that is accessible through the query results (not shown in the Fig.)

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

The present invention has been described with a certain degree of particularity, but those versed in the art will readily appreciate that various alterations and modifications may be carried out without departing from the scope of the following claims:

1. A method for dynamically constructing a scalable content warehouse for information that includes semi-structured data, comprising:
i. acquiring data from a plurality of data repositories, at least some of which store data that is selected from a group that consists of semi-structured data or non-structured data;
ii. enriching and storing the acquired data in a storage giving rise to semi-structured stored data; said enriching includes utilizing enriching utilities, at least some of which are semi-structured related enriching utilities;
iii. providing semi-structured access and query utilities for accessing the stored semi-structured data.

2. The method according to claim 1, wherein said data in semi-structured form being in Markup Language (ML).

3. The method according to claim 1, wherein said data in semi-structured form being in eXtendible Markup Language (XML).

4. The method according to claim 3, wherein said semi-structured related enriching utilities include at least one utility for converting to XML form.

5. The method according to claim 4, wherein said semi-structured related enriching utilities further include at least one linguistic enrichment utility.

6. The method according to claim 5, wherein said at least one linguistic enrichment utility, include: Extract concepts that may be associated with a content element enrichment utility; Isolate a portion of content element and tag it with meta information; Build a summary of a content element.

7. The method according to claim 1, wherein said storing includes:
i) providing document structure summaries of numerous semi-structured documents of said semi-structured data;
ii) constructing, one or more views that depend on at least the document structure summaries;
iii) constructing one or more index scheme for the semi-structured documents;
the at least one view and at least one index serve for structured querying of the semi-structured documents, irrespective of the number of different structures of said document structure summaries.

8. The method according to claim 7, further comprising repeating said (i) to (iii) each time in respect to different domain, each domain signifies semantically related semi-structured documents.

9. The method according to claim 7, wherein, said views include, each
i) at least one abstract structure of concepts; and
ii) mappings between the at least one abstract structure of concepts and the document structure summaries.

10. The method according to claim 7, wherein each document summary being a concrete Document type Definition (DTD).

11. The method according to claim 9, wherein each abstract structure of concepts being an abstract DTD.

12. The method according to claim 9, wherein said abstract structure of concepts includes a set of paths and wherein each one of the document structure summaries includes a set of paths, and wherein said mappings being from each path in the abstract structure of concepts to a respective path in selected document structure summaries.

13. The method according to claim 9, wherein said abstract structure of concepts being an abstract DTD that includes a set of paths and wherein each one of the documents structure summaries being a concrete DTDs that includes a set of paths, and wherein said mappings being from each path in the abstract DTD to a respective path in selected concrete DTDs.

14. The method according to claim 7, wherein said index scheme, includes:
for each word in every semi-structured document, pairs each of which consisting of: (i) an identification of the document and (ii) a code indicative of the location of the word in the document and a relationship between the word and other words in the document.

15. The method according to claim 7, wherein each document summary being an XML schema.

16. The method according to claim 1, further comprising:
i) providing a query for the semi-structured data, the query includes indication of relevance ranking of sought results; wherein said indication includes specification according to the structural positioning of words in the semi-structured data;
ii) evaluating the query vis-a-vis the semi-structured data in accordance with said indicated relevance ranking; and
iii) providing at least one result, if any, where each result includes a portion of said semi-structured data that meets said query.

17. The method according to claim 16, wherein said evaluating is performed in a pipelined fashion including: said evaluating is stopped upon meeting a pre-defined evaluation criterion.

18. The method according to claim 17, wherein said criterion being a number of the results reaching or exceeding a predefined number.

19. The method according to claim 17, wherein in response to a user command said evaluation is resumed, and wherein said evaluation step (b) further includes:
resuming evaluating the query vis a vis the data that were not evaluated before.

20. The method according to claim 16, wherein said evaluating step (b) includes:
evaluating said query against said semi-structured data in a non-pipelined manner.

21. The method according to claim 16, wherein said evaluating step (b) includes:
evaluating said query vis-a-vis said semi-structured data in either mode (A) or (B) depending upon a predefined criterion, wherein (A) being a non-pipelined and (B) being pipelined.

22. The method according to claim 21, wherein said predefined criterion is based on a statistical model that estimates the number of results and wherein in case of large number of estimated results, said pipelined evaluation (B) is selected and in case of estimated small number or zero results said non-pipelined evaluation (A) is selected.

23. The method according to claim 17, wherein said indicating relevance ranking being by means of BESTOF operator, where BESTOF being defined as BESTOF (F, SP, P1, P2, P3, . . . )
Where:
F: a forest of XML nodes;
SP: a string predicate;
P1, P2, . . . , Pn: 1 to many XPath expressions;
The result of the BESTOF operation is a re-ordered sub-part of the forest F defined as follows: BESTOF (F, SP, P1, P2, . . . , Pn)=Fres={N1, N2, N3, . . . , Nm} with:
For all nodes N in F, if there exists j in [1,n] such that Pj applied to N satisfies SP then N is part of Fres.
For all i in [1, m] there exists j in [1,n] such that Pj applied to Ni satisfies SP. Let jmin(i) be the smallest such j for a given I
For all i in [1, m−j1], (jmin(i)<jmin(i+1)) or (jmin(i)=jmin(i+1) and Ni is before Ni+1 in F).

24. The method according to claim 23, wherein using said operator includes invoking LAUNCHRELAX, RELAX and FTISCAN functions.

25. A system for dynamically constructing a scalable content warehouse for information that includes semi-structured data, comprising:
acquiring module configured to acquire data from a plurality of data repositories, at least some of which store data that is selected from a group that consists of semi-structured data or non-structured data;
enriching module and associated store module configured to enrich and store the acquired data in a storage giving rise to semi-structured stored data; said enriching module includes utilizing enriching utilities, at least some of which are semi-structured related enriching utilities;
information delivery module configured to provide semi-structured access and query utilities for accessing the stored semi-structured data.

26. The system according to claim 25, further comprising Querying Browsing and Annotation module, configured to browse the stored data.

27. The system according to claim 25, wherein said store and information delivery further include:
a plurality of repository machines storing, each, semi-structured documents and document structure summaries that are associated with at least one cluster;
a plurality of interface machines storing each the same at least one abstract structure of concepts; the abstract structure of concepts are associated with clusters taken from the set of clusters;
a plurality of index machines storing, each, at least one sub-view mappings for document structure summaries and at least one abstract structure of concepts, the sub-view mappings are associated, each, with at least one cluster from said set of clusters;
the plurality of index machines storing, each, at least one sub-index; the sub-indexes are associated, each, with at least one cluster from said set of clusters;
each interface machine is further configured to perform at least the following:
pre-process a structured query using at least one abstract structure of concepts and determining query induced abstract structure of concepts, to thereby constitute inquiring interface machine
identify rapidly at least one of said index machine according to the at least one cluster of the query induced abstract structure of concepts, and communicate said query induced abstract structure of concepts to the at least one index machine;
each index machine in response to said communication is further configured to perform, at least the following
translating said at least one query induced abstract structure of concepts, utilizing selectively at least one of said sub-view mappings into corresponding at least one query induced document structure summary;
evaluating said at least one query induced document structure summary utilizing selectively at least one of said sub-indexes, as to identify at least one semi-structured document, if any, that meets said query;
identify rapidly at least one of said repository machines, according to the identified at least one semi-structure document;
each repository machine, in response to said communication is further configured to perform, at least the following
extracting the at least one semi-structured document, and communicating them to the inquiring interface machine, and displaying the query results.

28. For use with the system of claim 27, an index machine storing at least one sub-view mappings for document structure summaries and at least one abstract structure of concepts, the sub-view mappings are associated, each, with at least one cluster from said set of clusters; the index machine further storing, each, at least one sub-index; the sub-indexes are associated, each, with at least one cluster from said set of clusters.

29. For use with the system of claim 27, an interface machine storing at least one abstract structure of concepts; the abstract structure of concepts are associated with clusters taken from the set of clusters.

30. For use with the system of claim 27, a repository machine storing semi-structured documents and document structure summaries that are associated with at least one cluster.

31. The system according to claim 27, wherein said documents are stored in Internet sites.

32. The system according to claim 25, wherein said store and information delivery further include:
a plurality of storage machines storing numerous semi-structured documents; each storage machine storing semi-structured documents that are associated with one or more clusters;
a plurality of end-user machines storing, each, a common global data associated with clusters;
a plurality of intermediate machines storing, each, sub view data and sub index data associated with one or more clusters;
each end-user machine is further configured to perform at least the following:
pre-process a structured query using the cluster data and assign one or more clusters to a query related data derivable from said structured query;
identify rapidly at least one of said intermediate machine according to the assigned at least one cluster;
communicate the query related data to the identified intermediate machine;
each intermediate machine, in response to said communication, is further configured to perform, at least the following
process the query related data using the sub view and sub index, to identify rapidly at least one storage machine that stores semi-structured documents, and communicate query data to the identified at least one storage machine;
each storage machine, in response to said communication, is further configured to perform, at least the following
extracting the semi-structured documents and provide query results to the inquiring end-user machine;
said structured querying is feasible irrespective of the number of different structures of said semi-structured documents.

33. A computer program product having a storage medium for storing computer code portion for performing the method steps of claim 1.

34. A computer program product having a storage medium for storing computer code portion for performing the method steps of claim 7.

35. A computer program product having a storage medium for storing computer code portion for performing the method steps of claim 16.
